(19) United States
(12) Patent Application Publication
(10) Pub. No.: US 2025/0239043 A1
(43) Pub. Date: Jul. 24, 2025

(54) REGION OF INTEREST DETECTION FOR IMAGE SIGNAL PROCESSING

(71) Applicant: Motional AD LLC, Boston, MA (US)

(72) Inventors: Lin Luo, South San Francisco, CA (US); Arthur Safira, Boston, MA (US); Ting Wang, Rancho Palos Verdes, CA (US)

(21) Appl. No.: 19/177,244

(22) Filed: Apr. 11, 2025

Related U.S. Application Data
(63) Continuation of application No. PCT/US2023/034853, filed on Oct. 10, 2023.
(60) Provisional application No. 63/580,516, filed on Sep. 5, 2023.
(60) Provisional application No. 63/488,672, filed on Mar. 6, 2023.
(60) Provisional application No. 63/416,412, filed on Oct. 14, 2022.

(51) Int. Cl. G06V 10/25; G06T 7/80; G06V 10/44; G06V 20/58; G06V 20/70; H04N 23/88

(52) U.S. Cl. CPC G06V 10/25; G06T 7/80; G06V 10/44; G06V 20/582; G06V 20/70; H04N 23/88; G06V 2201/07

(57) ABSTRACT

Provided are methods for customized tags for annotating sensor data, which can include receiving vehicle data associated with a vehicle, identifying a location of the vehicle based at least in part on the vehicle data, identifying a feature, in a map based coordinate system, associated with the location of the vehicle, transposing a location of the feature from the map based coordinate system to an image sensor based coordinate system, identifying a region of interest in the image sensor based coordinate system based at least in part on the feature, routing the region of interest to an image sensor for image signal processing of sensor data based on the region of interest. Systems and computer program products are also provided.

### RELATED APPLICATIONS

This application is a continuation of PCT Patent Application No. PCT/US2023/034853, filed on Oct. 10, 2023, entitled “REGION OF INTEREST DETECTION FOR IMAGE SIGNAL PROCESSING,” which claims priority to U.S. Provisional Patent Application No. 63/416,412, filed on Oct. 14, 2022, entitled “LOCATION BASED REGIONS OF INTEREST FOR IMAGE SIGNAL PROCESSING AND REGION OF INTEREST DETECTION UTILIZING FEATURES IDENTIFIED FROM SENSOR DATA,” U.S. Provisional Patent Application No. 63/488,672, filed on Mar. 6, 2023, entitled “REGION OF INTEREST DETECTION FOR IMAGE SIGNAL PROCESSING,” and U.S. Provisional Patent Application No. 63/580,516, filed on Sep. 5, 2023, entitled “REGION OF INTEREST DETECTION FOR IMAGE SIGNAL PROCESSING,” each of which is incorporated herein by reference in its entirety.

### BACKGROUND

Autonomous vehicles typically use sensor data to perceive the area around them. Identifying image sensor parameters for performing image signal processing on the sensor data to enable a neural network to identify environmental features can be difficult and complicated.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIG. 4C is a diagram illustrating example operation of a CNN;

FIG. 4D is a diagram illustrating example operation of a CNN;

FIG. 5 is a block diagram illustrating an example of a signal processing system;

FIG. 6 is an example pictorial diagram illustrating an example region of interest;

FIG. 7A is a flowchart for identifying an environmental feature from sensor data;

FIG. 7B is a flowchart for identifying an environmental feature from sensor data;

FIG. 7C is a flowchart for detecting a region of interest based on an environmental feature identified from sensor data;

FIG. 8 is a flow diagram illustrating an example of a routine implemented by one or more processors to detect a location based region of interest; and

FIG. 9 is a flow diagram illustrating an example of a routine implemented by one or more processors to detect a region of interest utilizing environmental features identified from sensor data.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships, or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when,” “upon,” “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has,” “have,” “having,” or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a signal processing system that detects a region of interest to determine image sensor parameters for image signal processing of sensor data. The signal processing system can dynamically determine a region of interest based on environmental features (e.g., environmental elements) identified from the sensor data. For example, the signal processing system can identify a location associated with an image sensor (e.g., a geographical location of a vehicle) and identify environmental features associated with the location. The signal processing system can utilize the environmental features associated with the location to identify a region of interest within the sensor data.

In another example, the signal processing system can process the sensor data and/or additional sensor data using a neural network and utilize the output of the neural network to identify environmental features within the sensor data. For example, the additional sensor data may include camera data associated with an image sensor and indicative of a camera image, radar data associated with an image sensor and indicative of a radar image, LiDAR data associated with an image sensor and indicative of a lidar image, location data associated with a location sensor and indicative of a location of a vehicle, acceleration data associated with an accelerometer and indicative of an acceleration of a vehicle, speed data associated with a speed sensor and indicative of a speed of a vehicle, rotation data associated with a gyroscope and indicative of a rotation of a vehicle, position data associated with a position sensor and indicative of a position of a vehicle, weather data associated with a weather sensor and indicative of weather (e.g., weather at a particular location associated with the vehicle), traffic data associated with a traffic sensor and indicative of traffic (e.g., traffic at a particular location associated with the vehicle), and/or any other sensor data.

Based on the identified environmental features within the sensor data and/or the additional sensor data, the signal processing system can identify a region of interest. The signal processing system can use the region of interest to determine an adjustment to the image sensor parameters for the sensor data. The signal processing system can utilize the adjustment to the image sensor parameters by proactively adjusting the image sensor parameters of one or more image sensors such that the one or more image sensors generate sensor data based on the image sensor parameters. As a non-limiting example, by adjusting the image sensor parameters of the one or more image sensors, the signal processing system can enable the one or more image sensors to process the sensor data to generate an image. The one or more image sensors can provide the image to a neural network to identify different environmental features of the image.

By virtue of the implementation of systems, methods, and computer program products described herein, an autonomous vehicle can more efficiently and accurately perform image signal processing. Additionally, the autonomous vehicle can more efficiently and accurately infer the image sensor parameters for an image sensor, adjust the image sensor parameters for the image sensor, and generate images of a scene using the image sensor such that a neural network can identify environmental features within the image. For example, an autonomous vehicle can reduce sensing latency by using a variable region of interest for the image sensor that is based on one or more environmental features of the sensor data. For example, the autonomous vehicle can dynamically identify a region of interest using environmental features (e.g., location data based environmental features, environmental features identified by a neural network, etc.). Therefore, the autonomous vehicle can more accurately determine parameters for the image sensor based on the variable region of interest such that the system can identify particular environmental features within an image. Based on the identified particular environmental features, the autonomous vehicle can more accurately and efficiently determine corresponding driving behaviors for implementation. For example, these techniques may be used to enable the autonomous vehicle to more precisely identify particular environmental features (e.g., traffic lights, pedestrians, vehicles, etc.) within an image and determine corresponding driving behaviors. By dynamically identifying the region of interest for image signal processing, the autonomous vehicle can achieve a more robust autonomous vehicle vision and perception system. Further, the dynamic region of interest can increase safety for the autonomous vehicle. For example, by reducing the sensing latency, the autonomous vehicle may be able to more quickly and more efficiently identify objects and/or environmental features of a scene and react accordingly.

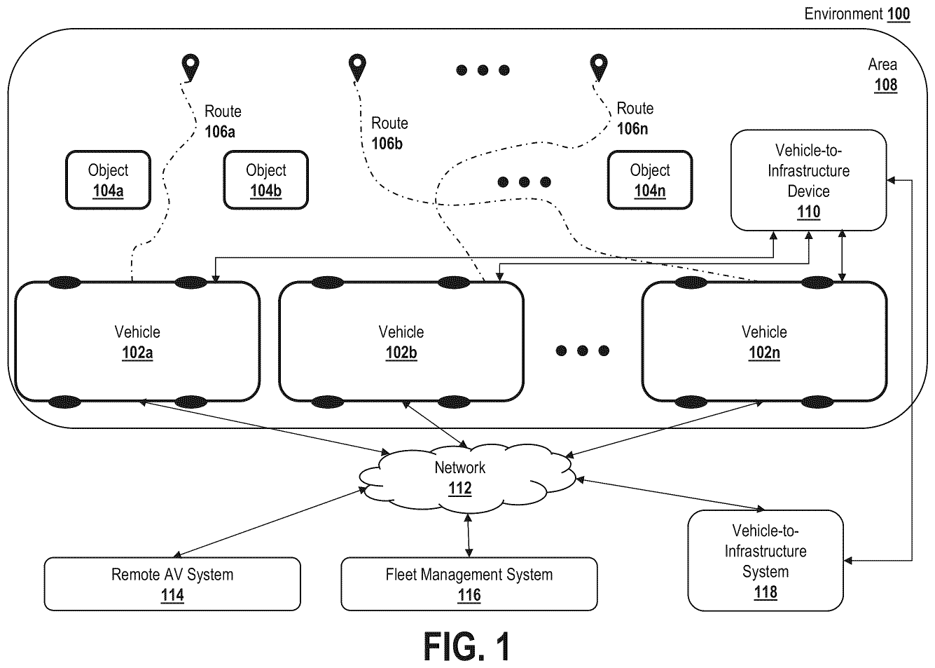

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

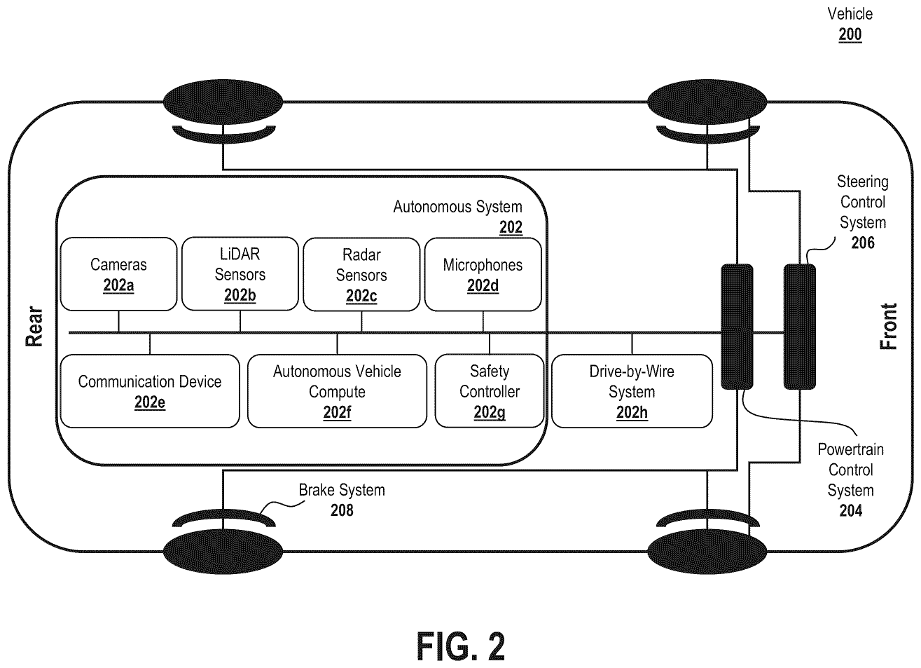

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. The vehicle 200 may also include a logging system (e.g., to store sensor data) and/or monitoring system (e.g., to monitor whether the system, particular components of the system, etc. are performing particular functions). In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

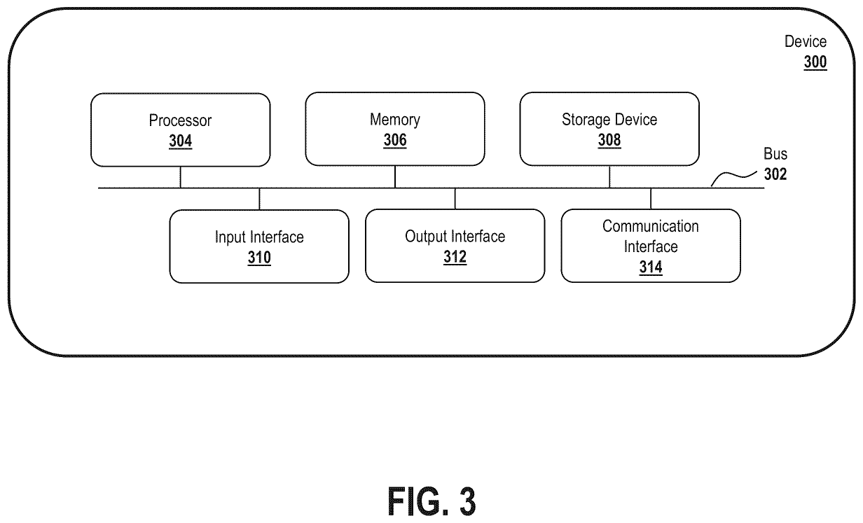

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of the remote AV system 114, at least one device of the fleet management system 116, at least one device of the vehicle-to-infrastructure system 118, and/or one or more devices of network 112 (e.g., one or more devices of a system of network 112). In some embodiments, one or more devices of vehicles 102 (e.g., one or more devices of a system of vehicles 102), at least one device of the remote AV system 114, at least one device of the fleet management system 116, at least one device of the vehicle-to-infrastructure system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, the processor 304 includes a processor (e.g., a central processing unit (CPU), a graphics processing unit (GPU), a neural processing unit (NPU) an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

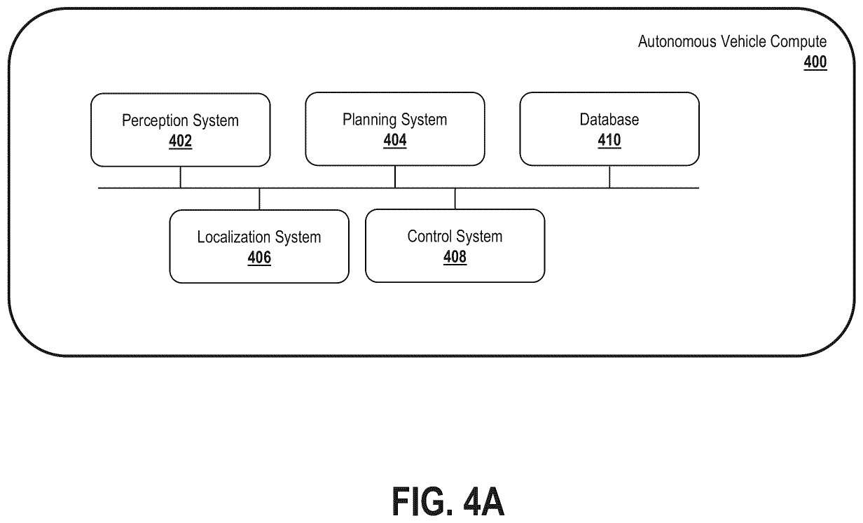

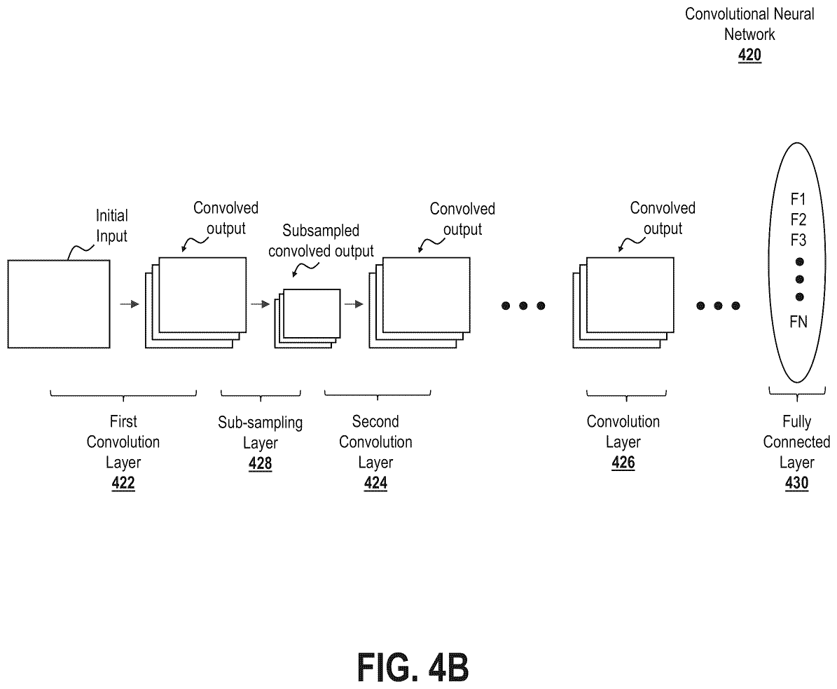

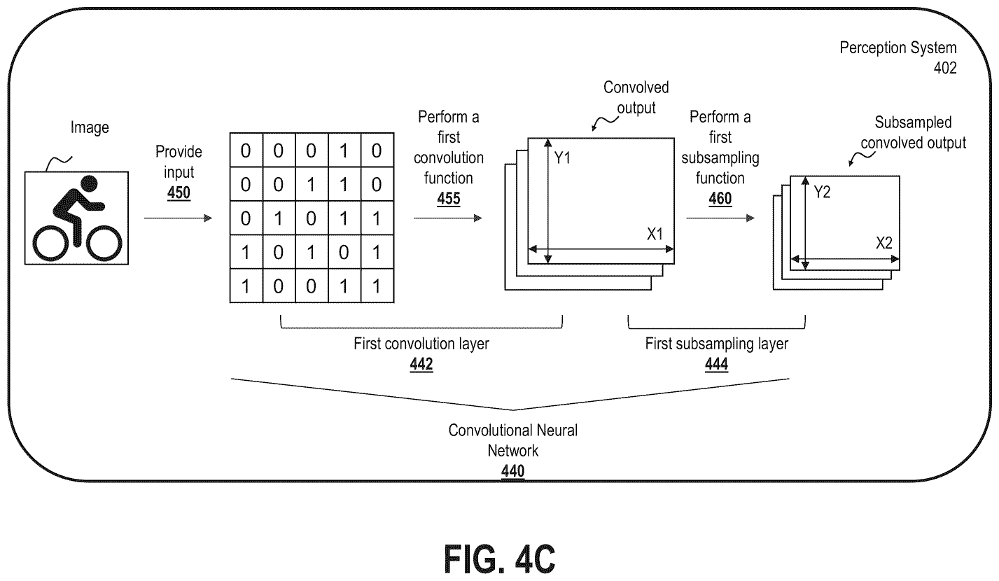

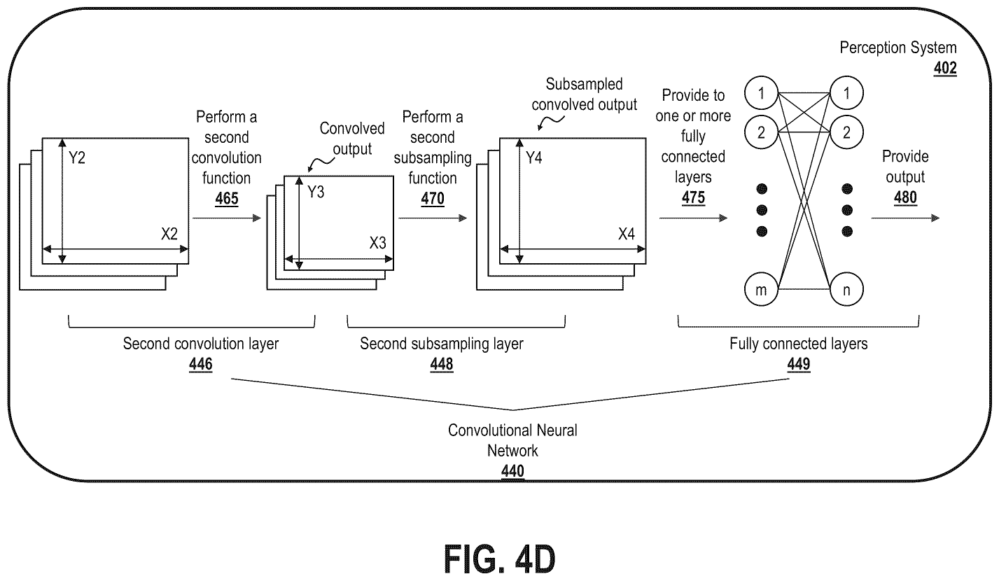

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of second convolutional layer 446 to corresponding neurons of a subsampling layer. In an example, CNN 440 provides the outputs of each neuron of second convolutional layer 446 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the second subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Variable Regions of Interest for Image Signal Processing

As an autonomous vehicle moves through an area, the environment around the vehicle can vary significantly. For example, the lighting characteristics of the environment around the vehicle can vary significantly when the vehicle is inside of a tunnel as compared to the lighting characteristics of the environment when the vehicle is outside of a tunnel. Additionally, the objects and/or environmental features of the environment can vary significantly. For example, a first environment around the vehicle may include one or more of traffic signs, pedestrians, vehicles, etc. and a second environment around the vehicle may include one or more of different traffic signs, different pedestrians, different vehicles, etc.

As discussed above, the vehicle may encounter a number of different objects and/or environmental features within an environment as the vehicle traverses the environment. In order to identify the objects and/or the environmental features, the vehicle can capture sensor data associated with an environment (e.g., an image of an environment). Further, the vehicle may implement a machine learning model to receive the sensor data and identify particular objects and/or environmental features within the image of the area. As the vehicle may encounter many different objects and/or environmental features while moving (e.g., birds, pedestrians, traffic signs, other vehicles, buildings, etc.), it may be important that the machine learning model be able to accurately identify objects and/or environmental features. For example, it may be important that the machine learning model be able to differentiate between a bird and a human as the vehicle may elect different actions based on whether the object is a bird (e.g., turn slightly) or a human (e.g., brake). The actions associated with encountering a first object may produce adverse effects when implemented when encountering a second object. Therefore, it may be important that the machine learning model accurately identifies different objects and/or environmental features within the image of the area. The machine learning model may identify different objects and/or environmental features (or classify objects and/or environmental features differently) based on the parameters of the sensors.

Sensors (e.g., image sensors) of the vehicle may utilize a static region of interest in the sensor data to determine parameters for the sensors and adjust how the sensor data is processed and produced. Sensors may utilize a global region of interest or a central region of interest in the sensor data to identify the parameters. For example, the sensors may utilize a default region of interest in a central location of the sensor data (e.g., an image frame). Additionally, the sensors may utilize a global region of interest that is shared between multiple sensors, a global region of interest that corresponds to an entire image frame, a global region of interest that is shared by a sensor across a plurality of locations, a global region of interest that is shared by a sensor across a plurality of time periods, etc.

The sensors may utilize the region of interest to identify how to adjust image sensor parameters of the sensors. The sensors may receive sensor data and may compare values (e.g., color values, exposure values, light values, intensity values, etc.) within the region of interest that are based on the image sensor parameters to particular values or ranges. For example, the sensors may measure the amount of light present in the region of interest and compare this value to a desired light value. Based on measuring the values within the region of interest, the sensors can determine overall adjustments to image sensor parameters for the generation of the sensor data such that the image sensor parameters for the portion of the sensor data corresponding to the region of interest and the image sensor parameters for the portion of the sensor data not corresponding to the region of interest are adjusted. In some cases, the sensors can perform metering based on the region of interest.

However, given that the adjustment of the parameters is based on a particular static region of interest, the sensor may undercorrect and/or overcorrect particular portions of the sensor data that are not located within the region of interest. For example, the adjustment may cause a portion of the sensor data located outside of the region of interest to become overexposed or underexposed. As the region of interest may not include a particular environmental feature that is of interest and is included in a different portion of the sensor data (e.g., a traffic sign, a pedestrian, etc.), the adjustment to the sensor data (that is based on the region of interest) may cause the particular environmental feature to be underprocessed or overprocessed such that a machine learning model may not correctly identify the particular environmental feature. Therefore, the use of such a static region of interest can make it difficult for a perception system (e.g., of an autonomous vehicle) to quickly and accurately identify objects or environmental features of an image. This can lead to an inadequate user experience as the perception system may be limited in the types and/or number of environmental features and/or objects that are identified by the perception system.

With respect to a global region of interest, as the sensor data may include an extensive set of sensor data that includes multiple objects and/or environmental features, it may be inefficient to adjust the parameters of the sensor based on the sensor data. For example, if the parameters of the sensor are adjusted based on the sensor data (e.g., all of the sensor data), the adjustment may cause one or more environmental features or objects to be underprocessed or overprocessed such that a machine learning model may not correctly identify the particular environmental features or objects.

With respect to a centralized (or otherwise static) region of interest, the sensor data may include an extensive set of potential regions of interest. For example, the sensor data may include 50, 75, 100, etc. potential regions of interest within the sensor data. In one example, the sensor data may be divided into a grid of potential regions of interest (e.g., a 10 by 10 grid of potential regions of interest). As the sensor data may include an extensive set of potential regions of interest, it may be inefficient to adjust the parameters of the sensors iteratively according to each of the potential regions of interest.

To address these issues, a perception system can use environmental features (e.g., location data based environmental features and/or machine learning model based environmental features) to dynamically identify a region of interest. The perception system can use the dynamically identified region of interest to adjust the parameters of the sensor. By dynamically identifying the region of interest based on one or more environmental features, the perception system can adjust the parameters of the sensor and increase the quantity of environmental features and/or objects identified by a machine learning model (e.g., quantity of a particular type of environmental features and/or objects), the quantity of different types of environmental features and/or objects identified by the machine learning model, etc. for sensor data from the sensor adjusted according to the parameters.

In some cases, the signal processing system can receive vehicle data associated with the vehicle and indicative of at least a location of the vehicle within an environment. For example, the vehicle data may include location data identifying a location of the vehicle, speed data identifying a speed of the vehicle, acceleration data identifying an acceleration of the vehicle, route data identifying a route of the vehicle, and/or mileage data identifying a mileage of the vehicle. The signal processing system can determine the geographic location of the vehicle and/or a sensor based on the location data.

Based on the geographic location, the signal processing system can identify an environmental feature in a map based coordinate system associated with the geographic location. For example, the environmental feature may include a traffic signal, a traffic sign, a road characteristic (e.g., a bridge, a pull off, an off ramp, an on ramp, a road closure, a traffic circle, a no-merge zone, etc.), a traffic marker (e.g., a traffic cone), a bicycle (e.g., another user may report, to the map based coordinate system, a bicycle on a particular section of the road), a vehicle (e.g., another user may report a vehicle (e.g., an abandoned, stopped, or inoperable vehicle), to the map based coordinate system, on a particular section of the road (e.g., on a pull off), a pedestrian, etc. The map based coordinate system may be a coordinate system (e.g., a two-dimensional, three-dimensional, etc. coordinate system) that corresponds to a map of an environment of the vehicle. For example, the map based coordinate system may correspond to a map of a town, a city, a state, etc. The signal processing system can identify a location of the environmental feature within the map based coordinate system associated with the geographic location.

The signal processing system can transpose the location of the environmental feature from the map based coordinate system to an image sensor based coordinate system. The image sensor based coordinate system may be a coordinate system (e.g., a two-dimensional, three-dimensional, etc. coordinate system) associated with the sensor and the sensor data. For example, the image sensor based coordinate system may be a coordinate system of the sensor data used by the sensor to define a region of interest of the sensor data. The signal processing system may identify a relationship between the map based coordinate system and the image sensor based coordinate system and utilize the relationship to transpose the location of the environmental feature. For example, the relationship may indicate that to transpose the location, one or more operations are to be performed. Further, the relationship may indicate that, to transpose the location, the location in the map based coordinate system should be adjusted by shifting, altering, transforming, etc. the location in the map based coordinate system.

The signal processing system may identify a region of interest in the image sensor based coordinate system based at least in part on the identified environmental feature and the transposing of the location of the environmental feature. The signal processing system may identify the region of interest as an area associated with (e.g., around) the environmental feature in the image sensor based coordinate system. For example, the signal processing system may identify the location of the environmental feature in the image sensor based coordinate system and may identify a region of interest of a certain radius around the location.

In some cases, to identify the region of interest, the signal processing system can receive sensor data from the sensor. For example, the additional sensor data may include camera data associated with a camera image, radar data associated with a radar image, LiDAR data associated with a lidar image, location data associated with a location sensor, acceleration data associated with an accelerometer, speed data associated with a speed sensor, rotation data associated with a gyroscope, position data associated with a position sensor, weather data associated with a weather sensor, traffic data associated with a traffic sensor, and/or any other sensor data. The signal processing system can process the sensor data using a machine learning model (e.g., a neural network). The machine learning model may be trained to identify particular environmental features and/or objects (e.g., traffic signs, traffic lights, pedestrians, vehicles, bicycles, planes, traffic signals, traffic markers, road characteristics (e.g., bridges, ramps, pull offs, off ramps, on ramps, road closures, a traffic circle, a no-merge zone, etc.), etc.) within the sensor data.

The signal processing system can identify a location of the identified environmental features and/or objects within the map based coordinate system based on processing the sensor data using the machine learning model. For example, the signal processing system can identify a location for all or a portion of the environmental features and/or objects identified by the machine learning model.

The signal processing system can transpose the location of the environmental feature from the map based coordinate system to the image sensor based coordinate system. Further, the signal processing system can identify a region of interest in the image sensor based coordinate system based on the identified environmental feature as discussed above.

The signal processing system can route the region of interest to the sensor for image signal processing. The sensor may identify one or more parameters of the sensor (e.g., one or more adjustments to parameters of the sensor) based on the region of interest and may process sensor data according to the one or more parameters. As the signal processing system can dynamically determine the region of interest based on the identified environmental feature, the signal processing system can dynamically adjust a location of the region of interest with respect to the sensor data.

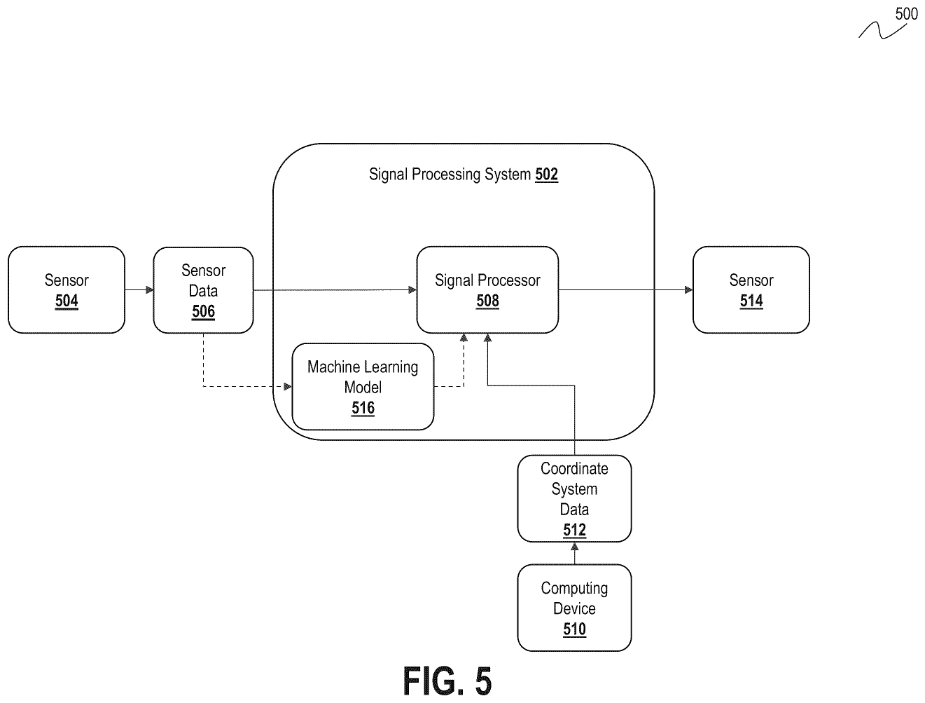

FIG. 5 is a block diagram illustrating an example of a signal processing environment 500. In the illustrated example, the signal processing environment 500 includes a signal processing system 502 communicatively coupled with a sensor 504, a computing device 510, and a sensor 514. In some cases, the signal processing system 502 can receive sensor data from multiple sensors 504. In some cases, the signal processing system 502 may form at least a part of a backend system (e.g., a backend system of the perception system 402, described with reference to FIG. 4A) that can receive sensor data and process the sensor data. Each of the plurality of sensors may be associated with (e.g., affixed to, monitoring an environmental feature of, etc.) a vehicle of a fleet of vehicles. In some cases, the sensor 504 and the sensor 514 may be the same sensor or different sensors.

The sensor 504 generates sensor data 506 based on one or more image signal parameters and communicates the sensor data 506 to the signal processing system 502 (e.g., the signal processor 508 of the signal processing system 502). The sensor 504 can include any one or any combination of a camera 202a, LiDAR sensor 202b, radar sensor 202c, a location sensor (e.g., a GPS sensor), an accelerometer, a speed sensor, a gyroscope, a position sensor, a weather sensor, a traffic data sensor, etc. Similarly, the sensor data 506 can include different types of sensor data, such as camera data associated with a camera image, radar data associated with a radar image, LiDAR data associated with a lidar image, location data associated with a location sensor, acceleration data associated with an accelerometer, speed data associated with a speed sensor, orientation data associated with a gyroscope, position data associated with a position sensor, weather data associated with a weather sensor, traffic data associated with a traffic data sensor, etc. The sensor 504 may generate sensor data 506 based on one or more image signal parameters (e.g., white balance, gain, tint, exposure, color balance, saturation, etc.). In some cases, the image signal parameters may be referred to as signal processing settings.

The sensor data 506 may include sensor data at arbitrary or preset levels or values. For example, the sensor 504 may utilize default image signal parameters to process the sensor data 506.

The signal processing system 502 can use the sensor data 506 generated by the sensor 504 to detect particular objects or environmental features in an image or scene. The vehicle 200 can utilize the detected objects or environmental features to make driving or path decisions.

The sensor 504 provides the sensor data 506 to the signal processing system 502 to identify a region of interest for the sensor 504 and/or the sensor 514. Further, the sensor 504 and/or the sensor 514 can utilize the region of interest to update how the sensor 504 and/or the sensor 514 identifies the region of interest.

In some embodiments, the signal processing system 502 may obtain the sensor data 506 from a different component. Further, the sensor 504 and/or a different component can perform preliminary signal processing to modify the sensor data 506 prior to the signal processing system 502 obtaining the sensor data 506.

The computing device 510 generates and provides coordinate system data 512 to the signal processing system 502. The coordinate system data 512 may include data identifying (e.g., defining) a map based coordinate system. For example, the coordinate system data 512 may identify a set of coordinates for an environment identified by the map based coordinate system. The set of coordinates may define a boundary of the environment of the vehicle.

In some cases, the coordinate system data 512 may include environmental feature data identifying one or more environmental features of the environment. For example, the coordinate system data 512 may identify a location of one or more of traffic signal, a traffic sign, a traffic marker, a road characteristic, a bicycle, a vehicle, a pedestrian, etc. within the map based coordinate system. Additionally, the coordinate system data 512 may identify a set of coordinates for all or a portion of the one or more environmental features. For example, the set of coordinates may include a latitude and a longitude. In another example, the set of coordinates may include an x-coordinate (e.g., relative to an x-axis), a y-coordinate (e.g., relative to a y-axis), and/or a z-coordinate (e.g., relative to a z-axis).

In some cases, the signal processing system 502 may periodically or aperiodically obtain updated coordinate system data 512. For example, the updated coordinate system data 512 may define updated boundaries of the environment of the vehicle. Additionally, the updated coordinate system data 512 may define updated environmental features of the environment (e.g., an updated location of the environmental features, removed environmental features, added environmental features, etc.).

The signal processing system 502 includes a signal processor 508 to process the sensor data 506 and/or the coordinate system data 512 to identify a region of interest to adjust a manner of determining the one or more image signal parameters by the sensor 504 and/or the sensor 514. For example, the signal processing system 502 can dynamically determine a region of interest for the sensor 504 and/or the sensor 514 and provide the region of interest to the sensor 504 and/or the sensor 514.

It will be understood that the signal processing system 502 can include fewer, more, or different components. For example, the signal processing system 502 can include multiple signal processors 508 performing different processing functions on the sensor data 506 and/or processing sensor data 506 from different sensors 504.

In some cases, the signal processing system 502 may include and/or implement a machine learning model 516 (e.g., a neural network). The machine learning model 516 may be trained to receive sensor data 506 as input and output one or more environmental features and/or objects within the sensor data 506. In some cases, the signal processing system 502 may include a plurality of machine learning models to process the sensor data 506. For example, the signal processor 508 may utilize the plurality of machine learning models to process the sensor data 506 to identify a plurality of environmental features of the sensor data 506. The machine learning model 516 may provide the one or more environmental features to the signal processor 508. In some embodiments, the signal processing system 502 may not include a machine learning model 516.

In some cases, the signal processor 508 can receive the sensor data 506 and/or the coordinate system data 512 and identify the environmental features within the sensor data 506. The sensor data 506 may include vehicle data. For example, the sensor data 506 may include acceleration data associated with the vehicle, orientation data associated with the vehicle, location data associated with the vehicle, speed data associated with the vehicle, position data associated with the vehicle, etc.

The location data of the vehicle may identify a current geographic location of the vehicle, a previous geographic location of the vehicle, and/or a future or predicted location of the vehicle. For example, a user of the vehicle may request transportation to a particular destination and the signal processing system 502 may obtain a predicted route of the vehicle from the origin of the vehicle to the destination and a current location of the vehicle. Therefore, the signal processing system 502 may predict the geographic location of the vehicle at different times (e.g., at the current time or at a future time).

The signal processor 508 can obtain the vehicle data and determine a location of the vehicle and/or the sensor 504. For example, the signal processor 508 can determine a location of the vehicle relative to a map.

In some cases, the coordinate system data 512 may include environmental feature data. The environmental feature data may identify one or more environmental features associated with one or more locations of the map based coordinate system. For example, the environmental feature data may indicate a traffic sign is located at a first location of the map based coordinate system, a bridge is located at a second location of the map based coordinate system, and a traffic signal is located at a third location of the map based coordinate system. Based on the environmental feature data and the vehicle data, the signal processor 508 can identify one or more environmental features (e.g., one or more environmental features associated with a location of the vehicle).

The signal processor 508 can identify the one or more environmental features. For example, the signal processor 508 can identify the one or more environmental features identified by the machine learning model 516 and/or identify one or more environmental features based on the sensor data 506 and/or the coordinate system data 512.

The signal processor 508 can identify a location of the one or more environmental features using the coordinate system data 512. For example, the signal processor 508 can identify coordinates of the one or more environmental features relative to the map based coordinate system using the coordinate system data 512. In some embodiments, the machine learning model 516 may be trained to output a location of the one or more environmental features relative to the map based coordinate system.

The signal processor 508 can transpose the one or more environmental features from the map based coordinate system to an image sensor based coordinate system. The image sensor based coordinate system may be a coordinate system utilized by the sensor 504 and/or the sensor 514. For example, the sensor 504 and/or the sensor 514 may generate sensor data relative to the image sensor based coordinate system. In some cases, the sensor 504 and/or the sensor 514 may provide coordinate system data to the signal processing system 502 defining the image sensor based coordinate system.

In some embodiments, the machine learning model 516 and/or the signal processor 508 may identify the environmental features (e.g., a location of the environmental features) relative to the image sensor based coordinate system. Therefore, in some cases, the signal processor 508 may not transpose the one or more environmental features from the map based coordinate system to the image sensor based coordinate system.

The signal processor 508 can identify a region of interest in the image sensor based coordinate system (e.g., based on transposing the one or more environmental features). The region of interest may correspond to a location in the image sensor based coordinate system relative to the one or more environmental features. For example, the region of interest may be an area around (e.g., within a particular radius of) the location of the one or more environmental features. In another example, the region of interest may be a portion of an image frame that includes the one or more environmental features.

The signal processor 508 routes the region of interest to the sensor 514. In some cases, the signal processor 508 may route the region of interest to the sensor 514 and/or the sensor 504. The sensor 514 and/or the sensor 504 may perform image signal processing based on the region of interest.

The sensor 504 and/or the sensor 514 can generate image sensor parameters for the image signal processing. As described herein, in some cases, the image sensor parameters used by the sensor 504 and/or the sensor 514 may be updated based on the region of interest provided by the signal processor 508. For example, the signal processor 508 may dynamically determine, from sensor data 506 associated with an image, a region of interest for the sensor data 506 (e.g., a different region of interest for the sensor data than the region of interest used by the sensor 504 to process the sensor data 506). Based on this determination, the signal processor 508 can generate provide the region of interest to the sensor 504 and/or the sensor 514 to improve the sensor data 506 generated by the sensor 504 and/or the sensor 514 and/or improve the manner in which the sensor data 506 is processed by the signal processor 508. For example, the image sensor parameters for the sensor 504 and/or the sensor 514 can include settings for how to capture and/or generate the sensor data 506, such as, white balance, gain, tint, exposure, color balance, and/or saturation, and the image sensor parameters for the sensor 504 and/or the sensor 514 can include settings for how to adjust, modify, or process the sensor data 506.

Based on dynamically determining the region of interest, the signal processing system can improve the safety and effectiveness of the vehicle 200. For example, the signal processing system 502 can use the sensor data 506 and/or the coordinate system data 512 to identify the region of interest.

The sensor 504 and/or the sensor 514 can use the image sensor parameters to generate and process additional sensor data 506. In some cases, using the image sensor parameters, the sensor 504 and/or the sensor 514 can adjust how the sensor 504 and/or the sensor 514 captures the sensor data 506 and processes the sensor data 506. For example, using (or based on) the image sensor parameters, the sensor 504 and/or the sensor 514 can generate sensor data 506 with a different setting for white balance, gain, tint, exposure, color balance, and/or saturation, etc.

### Example Regions of Interest

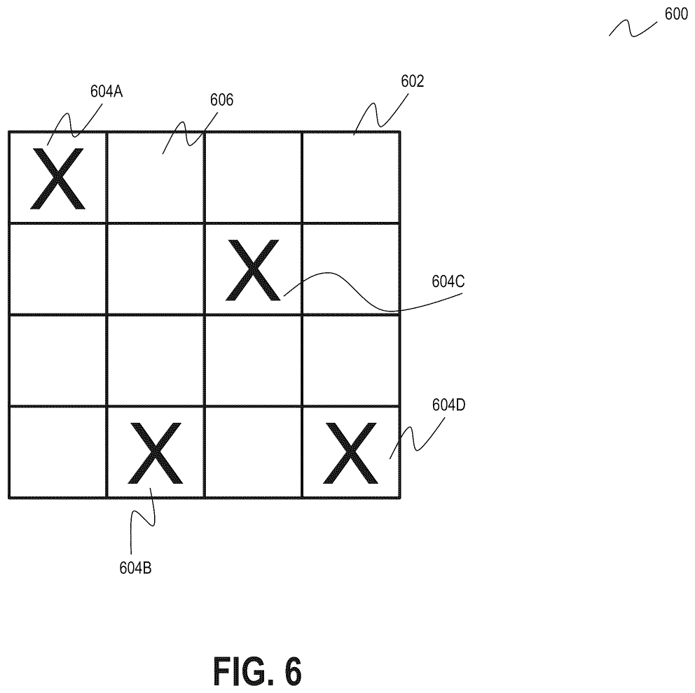

FIG. 6 is example pictorial diagram 600 illustrating example regions of interest 604A, 604B, 604C, and 604D. The example pictorial diagram 600 illustrates example sensor data 602. For example, the example sensor data 602 can include an image frame. Further, the image frame may depict a particular scene. The example pictorial diagram 600 defines the regions of interest 604A, 604B, 604C, and 604D according to an image sensor based coordinate system.

As discussed herein, a signal processing system may dynamically identify the regions of interest 604A, 604B, 604C, and 604D based on identified environmental features. For example, the signal processing system may utilize location data and/or the output of a machine learning model to identify particular environmental features in sensor data. The signal processing system may identify a region of interest corresponding to the identified environmental features.

The signal processing system may identify a location of the identified environmental features in a map based coordinate system. For example, the signal processing system may determine a location of the identified environmental features in a map based coordinate system relative to a world map. As coordinates of the map based coordinate system may not be understandable by sensors and/or the sensors may be unable to understand a meaning of the coordinates of the map based coordinate system relative to the map based coordinate system, the signal processing system may transpose the coordinates to a coordinate system associated with the sensor (e.g., an image sensor based coordinate system).

As illustrated in FIG. 6, the example sensor data 602 illustrates the sensor data relative to an image sensor based coordinate system. The image sensor based coordinate system may define coordinates of the sensor data. For example, the image sensor based coordinate system may define a set of coordinates for a graph (e.g., with a horizontal axis (x-axis) and a vertical axis (y-axis)). Each set of coordinates defining a position within the sensor may include an x-axis value and a y-axis value. For example, each set of coordinates may include a set of values bounded by a set of parentheses (e.g., a (x-axis value, y-axis value)). In some cases, each set of coordinates may include more, less, or different values.

In the example of FIG. 6, the image sensor based coordinate system may have a y-axis value of 1 and an x-axis value of 1 in the bottom left corner of the example sensor data. For each subsequent region in the y-axis (e.g., when moving up), the y-axis value may increase by 1 and for each subsequent region in the x-axis (e.g., when moving to the right), the x-axis value may increase by 1.

Each of the regions of interest 604A, 604B, 604C, and 604D is associated with a set of coordinates relative to the image sensor based coordinate system. For example, a first region of interest 604A is associated with a first set of coordinates (1,4) defining a location of the first region of interest 604A in the image sensor based coordinate system, a second region of interest 604B is associated with a second set of coordinates (2,1) defining a location of the second region of interest 604B in the image sensor based coordinate system, a third region of interest 604C is associated with a third set of coordinates (3,3) defining a location of the third region of interest 604C in the image sensor based coordinate system, and a fourth region of interest 604D is associated with a fourth set of coordinates (4,1) defining a location of the fourth region of interest 604D in the image sensor based coordinate system.

The example sensor data 602 further includes a plurality of regions of the sensor data 602 that are not associated with regions of interest. For example, the coordinates (1,1), (1,2), (1,3), (2,2), (2,3), (2,4), (3,1), (3,2), (3,4), (4,2), (4,3), and (4,4) define regions that are not regions of interest.

The signal processing system may provide the coordinates for all or a portion of the regions of interest to the sensor. For example, the signal processing system can provide coordinates (1,4), (2,1), (3,3), and (4,1) to the sensor such that the sensor can identify the regions of interest based on the signal processing system defining the regions of interest according to the image sensor based coordinate system.

Different sensor data may have different region(s) of interest. For example, a sensor associated with a vehicle in a first environment may have a first set of regions of interest and the sensor associated with the vehicle in a second environment may have a different second set of regions of interest. Therefore, the same sensor can use different regions of interest (defining different locations in the sensor based coordinate system) at different locations, different environments, different time periods. The regions of interest may be different based on the movement of the vehicle (e.g., based on different environmental features at different geographic locations). For example, the first environment may include multiple pedestrians, traffic signals, traffic signs, etc. and the second environment may not include pedestrians, traffic signals, and/or traffic signs. As the signal processing system can dynamically adjust the region(s) of interest based on the environment (and the corresponding environmental features) of the vehicle, the sensors are able to accurately and efficiently adjust image sensor parameters.

In some cases, different sensors (e.g., sensors associated with different vehicles, different sensors associated with the same vehicle, etc.) may utilize different regions of interest (defining different locations in the sensor based coordinate system).

The adjustment of the regions of interest (and the image sensor parameters) by the signal processing system (and the sensor) may be tuned to distinct geographic locations. For example, the signal processing system may identify different regions of interest for different geographic locations of the vehicle (e.g., outside of a tunnel, crossing a bridge, driving through a town, etc.). The signal processing system may determine a first region of interest for a first geographic location and a second region of interest for a second geographic location. Further, the sensor may determine first image sensor parameters for a first geographic location and second image sensor parameters for a second geographic location.

The adjustment of the regions of interest (and the image sensor parameters) by the signal processing system (and the image sensor) may be tuned to particular outputs of a machine learning model. For example, for a machine learning model output identifying a pedestrian, a vehicle, a bicycle, etc., the signal processing system may identify different environmental features and different regions of interest. The signal processing system may determine a first region of interest based on machine learning model output identifying a first environmental feature located in a first location of the environment and a second region of interest based on machine learning model output identifying a second environmental feature located in a second location of the environment.

### Example Operating Diagrams of Signal Processor

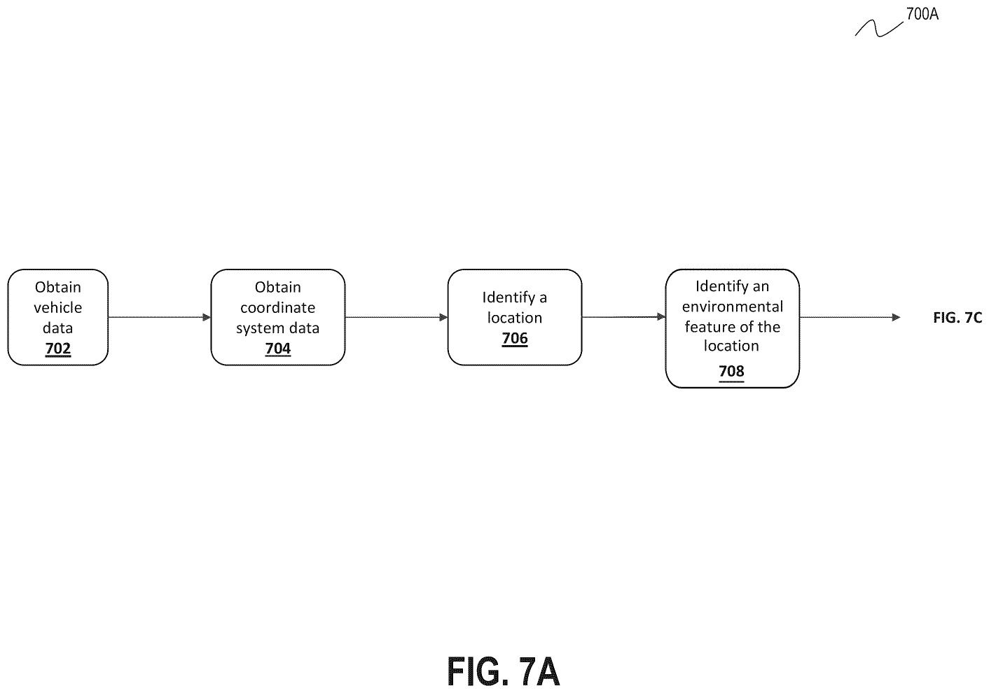

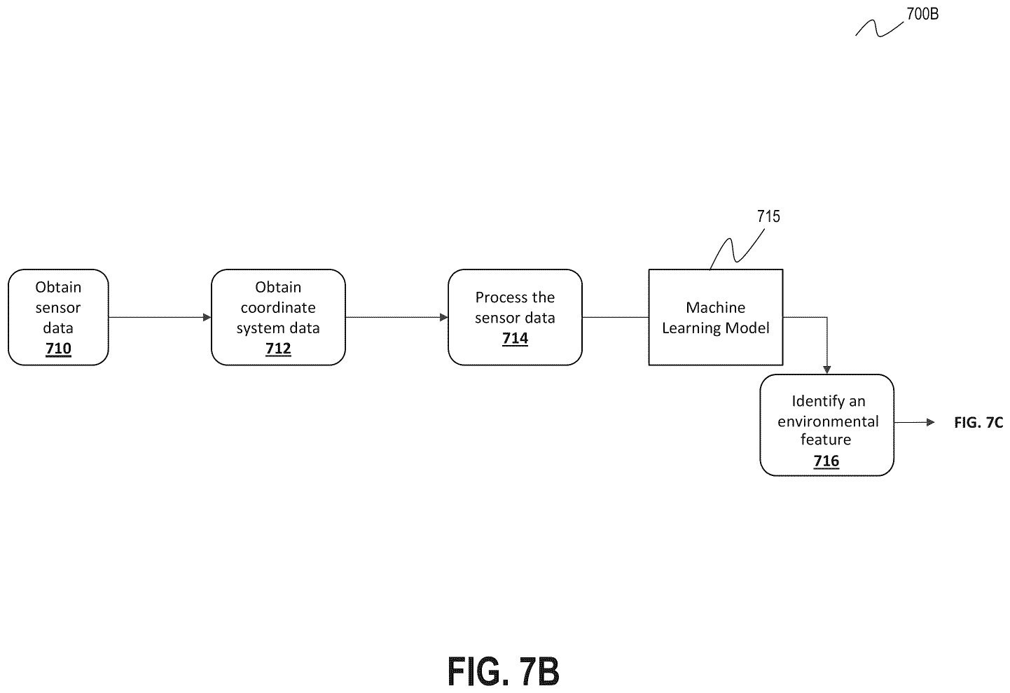

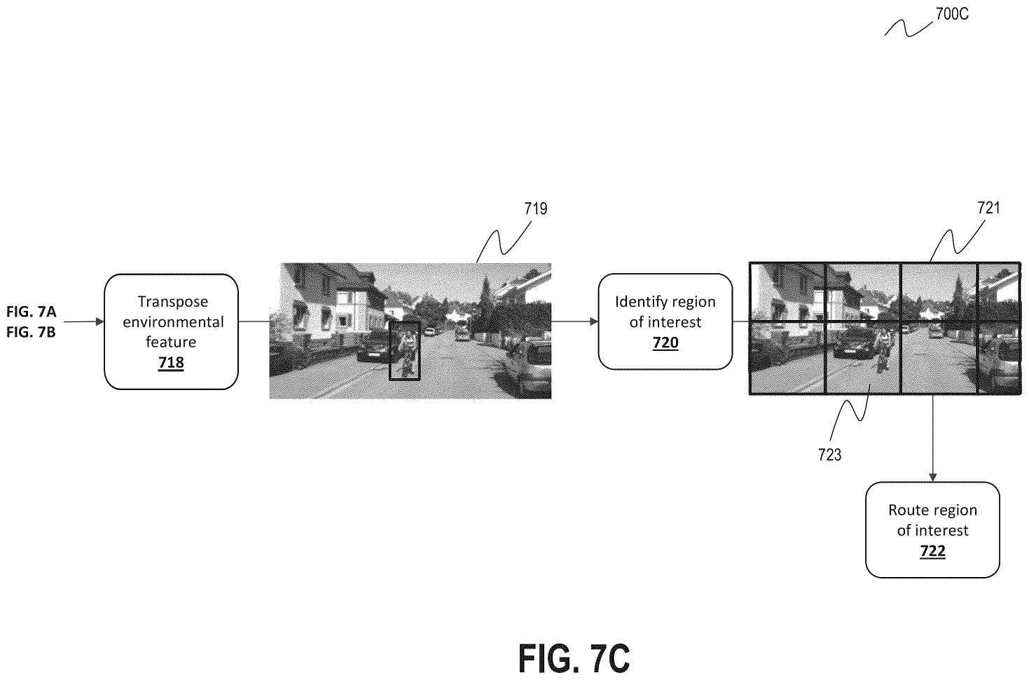

FIGS. 7A, 7B, and 7C are operation diagrams illustrating a data flow for identifying regions of interests. Specifically, FIGS. 7A, 7B, and 7C are operation diagrams illustrating a data flow for identifying environmental features of sensor data and determining regions of interest based on the identified environmental features. Any component of the perception system 402 can facilitate the data flow for identifying the region(s) of interests. In some embodiments, a different component can facilitate the data flow. In the example of FIGS. 7A, 7B, and 7C, a signal processing system facilitates the data flow.

FIG. 7A is an operation diagram 700A for identifying an environmental feature based on vehicle data. At step 702, the signal processing system receives vehicle data associated with a vehicle. As described herein, the vehicle data can include data from one or more sensors, components, etc. of the vehicle. For example, the vehicle data may include location data identifying a location of the vehicle, speed data identifying a speed of the vehicle, acceleration data identifying an acceleration of the vehicle, route data identifying a route of the vehicle, and/or mileage data identifying a mileage of the vehicle.

At step 704, the signal processing system obtains coordinate system data. The coordinate system data can define a map based coordinate system. For example, the coordinate system data may define an origin point of the map based coordinate system. Further, the coordinate system data may define a range of values for all or a portion of the coordinates of the map based coordinate system. For example, the coordinate system data may indicate that the map based coordinate corresponds to an x-axis coordinate and a y-axis coordinate. The coordinate system data may indicate that the origin point is (0,0) and that the x-axis coordinate has a value of [0,10] and the y-axis coordinate has a value of [0,10]. Further, the coordinate system data may indicate that the value of the x-axis coordinate increases in value from the left to the right of the sensor data and the value of y-axis coordinate increases in value from the bottom to the top of the sensor data. In some cases, one or more coordinates may have different ranges.

At step 706, the signal processing system identifies a location. The signal processing system may identify a location of the vehicle based on the vehicle data. For example, the signal processing system may determine a geographic location of the vehicle within an environment. The signal processing system can determine a current geographic location of the vehicle and/or a future geographic location of the vehicle. For example, the signal processing system can utilize current location data of the vehicle to identify the current geographic location of the vehicle (e.g., a pair of longitude and latitude coordinates identifying the geographic location of the vehicle and/or determine a location based on other sensor data such as LiDAR data). Further, the signal processing system can utilize route data (e.g., a route of the vehicle) to determine future or predicted geographic locations of the vehicle. For example, the signal processing system may predict a location of the vehicle at a certain point in the future (e.g., ten minutes in the future).

In some cases, the signal processing system can determine the geographic location of the vehicle and/or a future geographic location of the vehicle based on a GPS system associated with the vehicle.

At step 708, the signal processing system identifies an environmental feature of the location. The signal processing system, based on the geographic location of the vehicle, can identify additional information from the GPS. For example, the signal processing system can identify particular environmental features such as traffic signs, traffic signals, bridges, work zones, road closures, tunnels, cities, forests, mountains, etc. and a proximity of the geographic location to these environmental features.

In some cases, to identify the environmental features, the signal processing system may provide the geographic location to another system (e.g., a third party service such as a traffic service, a government service, etc.) to determine the environmental features at the geographic location. Therefore, the signal processing system can determine the environmental feature(s) at the geographic location.

In some cases, the environmental feature may include a time of day and/or a weather associated with the geographic location. The signal processing system can also utilize the geographic location of the vehicle to identify time of day data associated with the geographic location and/or weather data associated with the geographic location. In some embodiments, the signal processing system may determine weather data and/or time of day associated with the signal processing system. For example, the signal processing system may determine a local time at the signal processing system.

The signal processing system may identify the time of day and/or a weather associated with the geographic location to adjust how regions of interest are identified. For example, the signal processing system may identify a first environmental feature (e.g., a bridge ices before road traffic sign) as corresponding to a region of interest when the weather is below a first threshold (e.g., 40 degrees Fahrenheit) and as not corresponding to a region of interest when the weather is above or equal to a second threshold (e.g., 40 degrees Fahrenheit) based on region of interest data identifying environmental features that correspond to regions of interest.

FIG. 7B is an operation diagram 700B for identifying an environmental feature based on the output of a machine learning model 715. At step 710, the signal processing system receives sensor data (e.g., image data) associated with a camera image. In the illustrated example, a camera image is used, however, it will be understood that different types of images or sensor data can be used. As described herein, the camera image can correspond to an image in a database that was generated from sensor data obtained from a camera, such as cameras 202a. In some cases, the camera image can include multiple rows of pixels in a matrix, and each pixel can include a value for red, green, and blue or a grayscale value. In some embodiments, the camera image may include annotations (e.g., identifying environmental features). In other embodiments, the camera image does not include annotations and/or may be referred to as an unannotated camera image.

At step 712, the signal processing system obtains coordinate system data. As discussed above, the coordinate system data can define a map based coordinate system including an origin point, range of values for all or a portion of the coordinates of the map based coordinate system, etc.

At step 714, the signal processing system processes the sensor data. The signal processing system may process the sensor data by providing the sensor data to the machine learning model 715. For example, the machine learning model 715 may be a neural network.

The machine learning model 715 may classify particular environmental features and/or objects in the sensor data. Further, the machine learning model 715 may be trained to receive as input sensor data and identify one or more environmental features in the sensor data. For example, the machine learning model 715 may be trained to identify one or more of traffic signal, a traffic sign, a traffic marker, a road characteristic, a bicycle, a vehicle, a pedestrian, etc.

Based on identifying the one or more environmental features in the sensor data, the machine learning model 715 may output coordinates of all or a portion of the environmental features in the sensor data relative to a map based coordinate system. For example, the machine learning model can output an x-axis value and a y-axis value for all or a portion of the environmental features in the map based coordinate system. In some cases, the machine learning model 715 may output coordinates of all or a portion of the environmental features in the sensor data relative to a sensor based coordinate system.

In some cases, the machine learning model 715 may be trained to identify particular environmental features (e.g., pedestrians) and may not be trained to identify other environmental features (e.g., planes). For example, the machine learning model 715 may be trained to identify pedestrians and may be trained to ignore planes. In some cases, the machine learning model 715 may be trained to identify particular environmental features that may be associated with a potential region of interest and ignore particular environmental features that may not be associated with a potential region of interest. For example, the machine learning model 715 can obtain region of interest data associated with the sensor that defines environmental features that are associated with a potential region of interest and/or environmental features that are not associated with a potential region of interest.

At step 716, the signal processing system identifies an environmental feature in the sensor data. The signal processing system may obtain the output of the machine learning model 715 identifying one or more environmental features in the sensor data. The signal processing system may further obtain the region of interest data associated with the sensor. Based on the region of interest data, the signal processing system may parse the output of the machine learning model to identify one or more environmental features associated with a region of interest. The signal processing system can obtain, from the machine learning model, location data associated with the one or more environmental features relative to the map based coordinate system. Therefore, the signal processing system can identify a location of one or more environmental features relative to the map based coordinate system.

FIG. 7C is an operation diagram 700C for identifying regions of interest based on the identified environmental features. As discussed above, the signal processing may identify one or more environmental features based on vehicle data (at step 708) and/or one or more environmental features based on the output of machine learning model 715 (at step 716).

At step 718, the signal processing system transposes the one or more environmental features. For example, the one or more environmental features may include one or more environmental features based on vehicle data (at step 708) and/or one or more environmental features based on the output of machine learning model 715 (at step 716). The signal processing system may transpose the one or more environmental features from the map based coordinate system to a sensor based coordinate system (e.g., a sensor based coordinate system associated with a sensor for adjustment of the image sensor parameters of the sensor). To transpose the one or more environmental features, the signal processing system can transpose (e.g., adjust, alter, transform, modify, etc.) all or a portion of the coordinates of the one or more environmental features.

The signal processing system may identify a relationship between the map based coordinate system and the sensor based coordinate system and utilize the relationship to transpose the location of the environmental feature. For example, the relationship may indicate a relationship between coordinates of the map based coordinate system and coordinates of the sensor based coordinate system (e.g., a 1:1 relationship, a 2:1 relationship, etc.) and/or how to modify coordinates of the map based coordinate system to obtain coordinates of the sensor based coordinate system.

Based on the transposing the one or more environmental features, the signal processing system generates sensor data 719 (e.g., an annotated image identifying an environmental feature in the image). As described herein, the sensor data 719 can correspond to a camera image.). The sensor data 719 may include an annotation identifying an environmental feature of the sensor data 719. In some cases, the sensor data 719 may include a plurality of environmental features.

At step 720, the signal processing system identifies the region of interest 723. The signal processing system identifies the region of interest 723 relative to regionalized sensor data 721. The sensor data 719 may be divided into multiple regions or regionalized sensor data 721 and the signal processing system can identify the region of interest 723 within the regionalized sensor data 721.

The signal processing system can obtain region of interest data identifying particular environmental features that correspond to potential regions of interest and particular environmental features that do not correspond to potential regions of interest. Further, the region of interest data may identify a size or area for each potential region of interest (e.g., relative to the environmental feature). For example, the region of interest data may identify different sizes (e.g., in pixels) for regions of interest with different numbers of environmental features. In some cases, the region of interest data may define potential regions of interest by a particular radius (e.g., a number of pixels) from the identified environmental feature (e.g., from the boundary of the identified environmental feature). Therefore, the signal processing system can define the region of interest 723 based on the region of interest data.

In some cases, the signal processing system can identify a region of interest 723 for all or a portion of the environmental features identified by the signal processing system. For example, the signal processing system can identify separate regions of interest 723 for all or a portion of the environmental features.

At step 722, the signal processing system routes the region of interest 723. The signal processing system routes the region of interest 723 to a sensor (e.g., the image sensor that generated the sensor data 719). Based on receiving the region of interest 723, the sensor can identify image sensor parameters for the sensor based on the region of interest (e.g., a brightness, contrast, saturation, etc.) and perform image signal processing of the sensor data based on the image sensor parameters. In some cases, the signal processing system may route the region of interest 723 to a separate system and the separate system may identify the image sensor parameters for the sensor based on the region of interest 723. In other cases, the signal processing system may identify the image sensor parameters for the sensor based on the region of interest 723. The separate system and/or the signal processing system may route the image sensor parameters to the sensor.

As described herein, the region of interest identification process can be repeated thousands, hundreds of thousands, millions, or more times in order to identify a region of interest to adjust image sensor parameters for image signal processing. By dynamically determining the region of interest, the sensor can more accurately perform image signal processing as compared to sensors that utilize static (e.g., global) regions of interest. This can enable a machine learning model to more accurately identify environmental features of the environment of the vehicle.

In addition, during the region of interest identification process, some of the functions or elements described herein may not be used or may not be present. For example, during the region of interest identification process, the identified environmental features may not be transposed.

### Example Flow Diagrams of Signal Processor

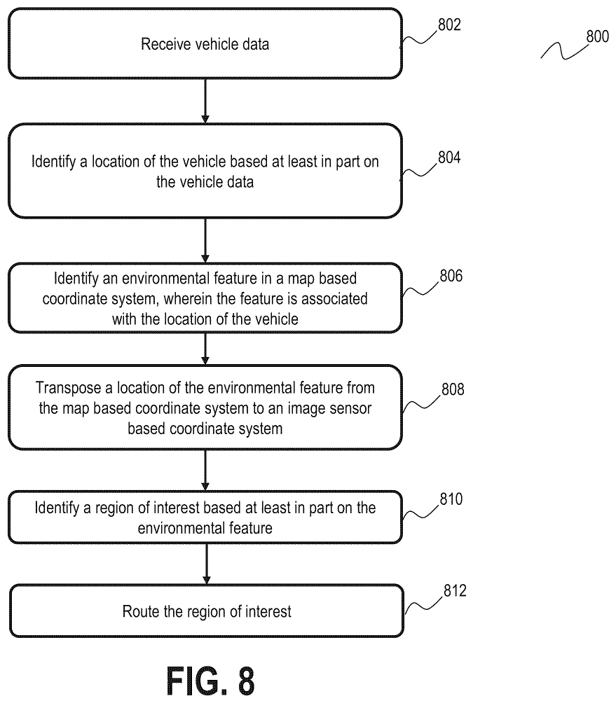

FIG. 8 is a flow diagram illustrating an example of a routine 800 implemented by one or more processors (e.g., one or more processors of the signal processing system 502). The flow diagram illustrated in FIG. 8 is provided for illustrative purposes only. It will be understood that one or more of the steps of the routine illustrated in FIG. 8 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 802, the signal processing system receives vehicle data. The vehicle data may be associated with a vehicle in an environment (e.g., being operated in the environment). The vehicle data may include at least one of speed data associated with the vehicle, acceleration data associated with the vehicle, location data associated with the vehicle, route data associated with the vehicle, or mileage data associated with the vehicle. The signal processing system may receive the vehicle data from one or more sensors, components, or systems (e.g., a GPS system) of the vehicle. In some cases, the signal processing system may receive a first subset of the vehicle data from a first sensor (e.g., an accelerometer) and a second subset of the vehicle data from a system (e.g., a GPS system).

At block 804, the signal processing system identifies a location of the vehicle based at least in part on the vehicle data. For example, the signal processing system may identify the location of the vehicle based on the location, the speed, the acceleration, the position, the orientation, etc. of the vehicle.

The signal processing system can identify coordinate system data identifying a map based coordinate system (e.g., a three-dimensional coordinate system). The map based coordinate system may identify a set of coordinates associated with a map (e.g., a map of an environment). The signal processing system can identify the location of the vehicle within the map based coordinate system.

At block 806, the signal processing system identifies an environmental feature, in a map based coordinate system, associated with the location of the vehicle. The environmental feature may include one or more of traffic signal (e.g., a traffic light), a traffic sign, a traffic marker, a road characteristic, a bicycle, a vehicle, a pedestrian, etc. The signal processing system may parse the coordinate system data to identify the environmental feature associated with the particular location of the vehicle. To identify the environmental feature, the signal processing system may identify a location of the environmental feature relative to a location of the vehicle in the map based coordinate system.

In some cases, the signal processing system may identify the environmental feature based on one or more annotations associated with the location of the vehicle. For example, the location of the vehicle may be associated with a user annotation identifying an environmental feature at the location. In some cases, the signal processing system can perform a web crawl to identify one or more environmental features at the location of the vehicle.

The signal processing system may obtain region of interest data. The region of interest data may identify a particular environmental feature, a particular type of environmental feature, etc. for potential regions of interest. The signal processing system may utilize the region of interest data to identify the environmental feature.

At block 808, the signal processing system transposes a location of the environmental feature from the map based coordinate system to an image sensor based coordinate system (e.g., a two-dimensional coordinate system). The transposed location of the environmental feature may reflect a location of the environmental feature relative to a location of the vehicle in the map based coordinate system. The signal processing system may transpose the location of the environmental feature from the map based coordinate system to the image sensor based coordinate system based on a relationship (e.g., identifying a shifting operation, translation operation, etc.) between the systems. The signal processing system may identify an intrinsic parameter of the sensor. For example, the intrinsic parameter may identify the image sensor based coordinate system. The signal processing system may transpose the location of the environmental feature based on the intrinsic parameter.

At block 810, the signal processing system identifies a region of interest based at least in part on the environmental feature. The signal processing system can identify the region of interest in the image sensor based coordinate system. The region of interest may include multiple sub-regions of interest. The sub-regions of interest may be disjointed or non-contiguous (e.g., separated by one or more non-regions of interest). In some cases, all or a portion of the sub-regions of interest may be located in a connected manner. All or a portion of the sub-regions of interest may be based on a particular environmental feature. For example, a first sub-region of interest may be based on a first environmental feature (e.g., a first pedestrian) and a second sub-region of interest may be based on a second environmental feature (e.g., a second pedestrian). Further, a first sub-region of interest may be based on a first environmental feature with a first environmental feature type (e.g., a vehicle) and a second sub-region of interest may be based on a second environmental feature with a second environmental feature type (e.g., a pedestrian).

At block 812, the signal processing system routes the region of interest. The signal processing system can route the region of interest to a sensor (e.g., an image sensor). For example, the sensor may be a radar sensor, a lidar sensor, etc. for image signal processing of sensor data based on the region of interest.

The signal processing system can transmit a command to cause the sensor to adjust an image sensor parameter of the sensor based on the region of interest. In some cases, the sensor and/or the signal processing system may adjust one or more image sensor parameters of the sensor (e.g., based on the command received from the signal processing system and the region of interest). For example, the signal processing system can transmit the command to cause the sensor to adjust one or more image sensor parameters including at least one of a brightness, a contrast, a white balance, a gain, a tint, an exposure, a saturation, or a color balance.

The sensor may perform image signal processing and may generate sensor data based on the command received from the signal processing system and the one or more image sensor parameters. For example, the signal processing system may transmit a command to cause the sensor to generate processed sensor data based on the adjusted image sensor parameter. In some cases, the signal processing system may transmit a command to cause the sensor and/or the signal processing system to process sensor data to generate an image of a scene and provide the image to an autonomous vehicle system (e.g., an autonomous vehicle vision and perception system). The autonomous vehicle system may identify an environmental feature and/or may perform one or more autonomous navigation operations (e.g., a turning operation, a braking operation, an acceleration operation, etc.).

In some cases, the signal processing system can receive updated vehicle data associated with the vehicle. The updated vehicle data may reflect an updated location of the vehicle. Based on the updated vehicle data, the signal processing system can identify an updated location of the vehicle. The signal processing system can identify a second environmental feature in the map based coordinate system associated with the updated location of the vehicle. As discussed above, the signal processing system can transpose a location of the second environmental feature from the map based coordinate system to the image sensor based coordinate system. Based on the second environmental feature, the signal processing system can identify a second region of interest in the image sensor based coordinate system and route the second region of interest. In some cases, the second region of interest and the region of interest may identify the same region of interest. In some cases, the second region of interest and the region of interest may identify different regions of interest. For example, the second region of interest and the region of interest may be associated with different coordinates in the image sensor based coordinate system.

It will be understood that the routine 800 can be repeated multiple times for identification of image signal parameter(s) for sensor(s). In some cases, the signal processing system 502 may iteratively repeat the routine 800 for multiple sets of sensor data received from the same sensor. Further, the signal processing system 502 may repeat the routine 800 for different sensors.

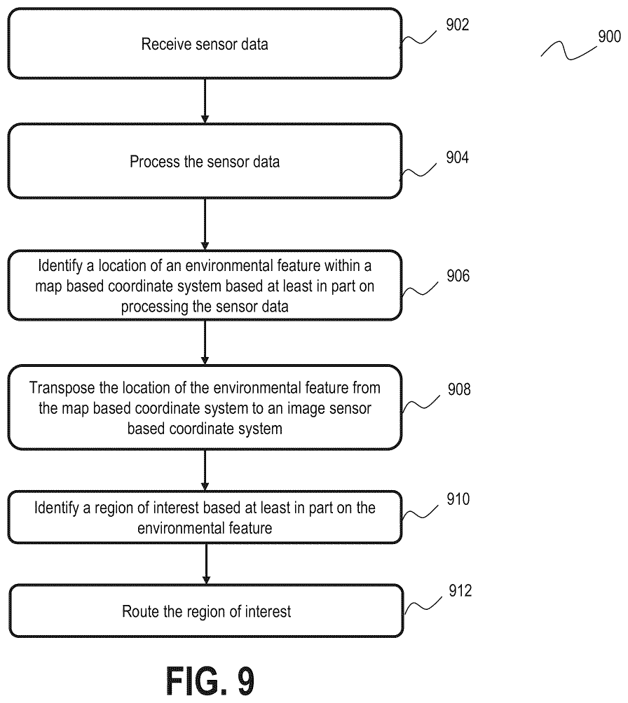

FIG. 9 is a flow diagram illustrating an example of a routine 900 implemented by one or more processors (e.g., one or more processors of the signal processing system 502). The flow diagram illustrated in FIG. 9 is provided for illustrative purposes only. It will be understood that one or more of the steps of the routine illustrated in FIG. 9 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 902, the signal processing system receives sensor data. A plurality of sensors (e.g., sensors associated with a vehicle) may capture the sensor data. The sensor data may include camera data associated with a camera image, radar data associated with a radar image, LiDAR data associated with a lidar image, location data associated with a location sensor, acceleration data associated with an accelerometer, speed data associated with a speed sensor, rotation data associated with a gyroscope, position data associated with a position sensor, weather data associated with a weather sensor, traffic data associated with a traffic sensor, and/or any other sensor data. Further, the sensor(s) that capture the sensor data may include a camera image sensor, a LiDAR sensor, a radar sensor, a location sensor (e.g., a GPS sensor), an accelerometer, a speed sensor, a gyroscope, a position sensor, a weather sensor, a traffic data sensor, or any other sensors.

The sensor data may include metadata identifying one or more environmental features of the sensor data (e.g., a vehicle associated with the sensor data, a time of capture of the sensor data, a sensor associated with the sensor data, or any other data associated with the vehicle and/or the sensor).

In some cases, the sensor data may be processed by a data ingestion system prior to the signal processing system 502 receiving the sensor data. The data ingestion system may process the sensor data and store the sensor data in a data store and the signal processing system 502 may receive the sensor data from the data store.

At block 904, the signal processing system processes the sensor data. The signal processing system can process the sensor data using a plurality of machine learning models. The machine learning models may be trained to obtain, as input, sensor data and output one or more environmental features (e.g., a location of one or more environmental features). The machine learning models may be trained to output (e.g., identify) particular environmental features and/or particular types of environmental features. For example, the machine learning models may be trained to identify a traffic signal, a traffic sign, a traffic marker, a pedestrian, a vehicle, a bicycle, a road characteristic, etc.

At block 906, the signal processing system identifies a location of the environmental feature within a map based coordinate system based at least in part on processing the sensor data. The machine learning model may output the location of the environmental feature within the map based coordinate system. In some cases, the signal processing system may separately identify a location of the environmental feature.

At block 908, the signal processing system transposes a location of the environmental feature from the map based coordinate system to an image sensor based coordinate system. Block 908 may correspond to block 808 as discussed above.

At block 910, the signal processing system identifies a region of interest based at least in part on the environmental feature. Block 910 may correspond to block 810 as discussed above.

At block 912, the signal processing system routes the region of interest. Block 912 may correspond to block 812 as discussed above. Further, the signal processing system may route the region of interest to the sensor from which the signal processing system receives the sensor data at block 902. The sensor data received at block 902 may be associated with a first frame and the sensor may utilize the region of interest to perform image signal processing on a second frame.

In some cases, the signal processing system can receive updated sensor data associated with the vehicle. The signal processing system can process the updated sensor data using the machine learning model. The signal processing system can identify a location of a second environmental feature in the map based coordinate system based on processing the updated sensor data using the machine learning model. As discussed above, the signal processing system can transpose a location of the second environmental feature from the map based coordinate system to the image sensor based coordinate system. Based on the second environmental feature, the signal processing system can identify a second region of interest in the image sensor based coordinate system and route the second region of interest. In some cases, the second region of interest and the region of interest may identify the same region of interest. In some cases, the second region of interest and the region of interest may identify different regions of interest. For example, the second region of interest and the region of interest may be associated with different coordinates in the image sensor based coordinate system.

It will be understood that the routine 900 can be repeated multiple times for identification of image signal parameter(s) for sensor(s). In some cases, the signal processing system 502 may iteratively repeat the routine 900 for multiple sets of sensor data received from the same sensor. Further, the signal processing system 502 may repeat the routine 900 for different sensors.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously recited step or entity.

Various additional example embodiments of the disclosure can be described by the following clauses:

Clause 1: A method, comprising:
receiving, using at least one processor, vehicle data associated with a representation of a vehicle and indicative of at least a location of the vehicle within an environment;
identifying, using the at least one processor, a location of the vehicle based at least in part on the vehicle data;
identifying, using the at least one processor, an environmental feature in a map based coordinate system, wherein the environmental feature is associated with the location of the vehicle;
transposing, using the at least one processor, a location of the environmental feature from the map based coordinate system to an image sensor based coordinate system;
identifying, using the at least one processor, a region of interest in the image sensor based coordinate system based at least in part on the environmental feature; and
routing, using the at least one processor, the region of interest to an image sensor for image signal processing of sensor data associated with a sensor based on the region of interest.

Clause 2: The method of Clause 1, wherein receiving the vehicle data comprises:
receiving at least one of speed data associated with a speed sensor and indicative of a speed of the vehicle, acceleration data associated with an accelerometer and indicative of an acceleration of the vehicle, location data associated with a location sensor and indicative of a location of the vehicle, route data associated with a first sensor and indicative of a route of the vehicle, or mileage data associated with a second sensor and indicative of a mileage of the vehicle.

Clause 3: The method of Clause 1 or Clause 2, wherein identifying the region of interest comprises:
identifying sub-regions of interest, wherein each of the sub-regions of interest is based on a particular environmental feature.

Clause 4: The method of Clause 3, wherein identifying the sub-regions of interest comprises:
identifying non-contiguous regions of interest.

Clause 5: The method of Clause 3 or Clause 4, wherein identifying the sub-regions of interest comprises:
identifying the sub-regions of interest that identify a set of environmental features, the set of environmental features comprising a first environmental feature associated with a first type of environmental feature and a second environmental feature associated with a second type of environmental feature.

Clause 6: The method of any one of Clauses 1 through 5, wherein identifying the environmental feature comprises:
identifying the environmental feature that identifies at least one of a traffic signal, a traffic marker, a road characteristic, a bicycle, a vehicle, a pedestrian, or a traffic sign.

Clause 7: The method of any one of Clauses 1 through 6, further comprising:
transmitting a command to cause the image sensor to adjust an image sensor parameter based on the region of interest.

Clause 8: The method of Clause 7, wherein transmitting the command comprises:
transmitting the command to further cause the image sensor to adjust at least one of brightness, contrast, white balance, gain, tint, exposure, saturation, or color balance.

Clause 9: The method of Clause 7 or Clause 8, wherein transmitting the command comprises:
transmitting the command to further cause the image sensor to generate the sensor data based on the adjusted image sensor parameter.

Clause 10: The method of Clause 9, wherein transmitting the command further comprises:
transmitting the command to further cause the image sensor to process the sensor data to generate an image of a scene and provide the image to an autonomous vehicle system.

Clause 11: The method of any one of Clauses 1 through 10, further comprising:
identifying an intrinsic parameter of the image sensor,
wherein transposing the location of the environmental feature from the map based coordinate system to the image sensor based coordinate system comprises:
transposing the location of the environmental feature from the map based coordinate system to the image sensor based coordinate system based on the intrinsic parameter of the image sensor.

Clause 12: The method of any one of Clauses 1 through 11, wherein identifying the environmental feature in the map based coordinate system comprises:
identifying the environmental feature in a three-dimensional coordinate system,
wherein transposing the location of the environmental feature from the map based coordinate system to the image sensor based coordinate system comprises:
transposing the location of the environmental feature from the three-dimensional coordinate system to a two-dimensional coordinate system,
wherein identifying the region of interest in the image sensor based coordinate system comprises:
identifying the region of interest in the two-dimensional coordinate system.

Clause 13: The method of any one of Clauses 1 through 12, wherein identifying the environmental feature comprises:
identifying the location of the environmental feature relative to the location of the vehicle,
wherein identifying the region of interest in the image sensor based coordinate system comprises:
identifying the region of interest further based at least in part on the location of the environmental feature relative to the location of the vehicle.

Clause 14: The method of any one of Clauses 1 through 13, further comprising:
receiving region of interest data associated with the vehicle and indicative of a type of environmental feature, wherein the environmental feature is associated with the type of environmental feature.

Clause 15: The method of any one of Clauses 1 through 14, further comprising:
receiving updated vehicle data associated with the vehicle and indicative of at least an updated location of the vehicle within the environment;
identifying the updated location of the vehicle based at least in part on the updated vehicle data;
identifying a second environmental feature, in the map based coordinate system, associated with the updated location of the vehicle;
transposing a location of the second environmental feature from the map based coordinate system to the image sensor based coordinate system; and
identifying a second region of interest in the image sensor based coordinate system based at least in part on the second environmental feature;
wherein routing the second region of interest comprises:
   routing the second region of interest based on identifying the second region of interest.

Clause 16: The method of Clause 15, wherein identifying the region of interest and identifying the second region of interest comprises:
identifying the second region of interest and the region of interest that are associated with different coordinates in the image sensor based coordinate system.

Clause 17: The method of any one of Clauses 1 through 16, further comprising:
identifying at least one annotation associated with the location of the vehicle, wherein the at least one annotation identifies the environmental feature.

Clause 18: A system, comprising:
at least one processor, and
at least one non-transitory storage media storing instructions that, when executed by the at least one processor, cause the at least one processor to:
   receive vehicle data associated with a representation of a vehicle and indicative of at least a location of the vehicle within an environment;
   identify the location of the vehicle based at least in part on the vehicle data;
   identify an environmental feature in a map based coordinate system, wherein the environmental feature is associated with the location of the vehicle;
   transpose a location of the environmental feature from the map based coordinate system to an image sensor based coordinate system;
   identify a region of interest in the image sensor based coordinate system based at least in part on the environmental feature; and
   route the region of interest to an image sensor for image signal processing of sensor data associated with a sensor based on the region of interest.

Clause 19: The system of Clause 18, wherein the image sensor adjusts an image sensor parameter based on the region of interest, wherein the image sensor parameter comprises at least one of brightness, contrast, white balance, gain, tint, exposure, saturation, or color balance.

Clause 20: At least one non-transitory storage media storing instructions that, when executed by a computing system comprising a processor, cause the computing system to:
receive vehicle data associated with a representation of a vehicle and indicative of at least a location of the vehicle within an environment;
identify the location of the vehicle based at least in part on the vehicle data;
identify an environmental feature in a map based coordinate system, wherein the environmental feature is associated with the location of the vehicle;
transpose a location of the environmental feature from the map based coordinate system to an image sensor based coordinate system;
identify a region of interest in the image sensor based coordinate system based at least in part on the environmental feature; and
route the region of interest to an image sensor for image signal processing of sensor data associated with a sensor based on the region of interest.

Clause 21: A method, comprising:
receiving, using at least one processor, first sensor data associated with a first sensor of a vehicle;
processing, using the at least one processor, the first sensor data using a neural network;
identifying, using the at least one processor, a location of an environmental feature within a map based coordinate system based at least in part on processing the first sensor data using the neural network;
transposing, using the at least one processor, the location of the environmental feature from the map based coordinate system to an image sensor based coordinate system;
identifying, using the at least one processor, a region of interest in the image sensor based coordinate system based at least in part on the environmental feature; and
routing, using the at least one processor, the region of interest to an image sensor for image signal processing of second sensor data associated with a second sensor based on the region of interest.

Clause 22: The method of Clause 21, wherein receiving the first sensor data comprises:
receiving at least one of camera data associated with a first image sensor and indicative of a camera image, location data associated with a location sensor and indicative of a location of the vehicle, acceleration data associated with an accelerometer and indicative of an acceleration of the vehicle, speed data associated with a speed sensor and indicative of a speed of the vehicle, rotation data associated with a gyroscope and indicative of a rotation of the vehicle, a position data associated with a position sensor and indicative of a position of the vehicle, weather data associated with a weather sensor and indicative of weather, traffic data associated with a traffic sensor and indicative of traffic, lidar data associated with a second image sensor and indicative of a lidar image, or radar data associated with a third image sensor and indicative of a radar image.

Clause 23: The method of Clause 21 or Clause 22, wherein identifying the region of interest comprises:
identifying sub-regions of interest, wherein each of the sub-regions of interest is based on a particular environmental feature.

Clause 24: The method of Clause 23, wherein identifying the sub-regions of interest comprises:
identifying non-contiguous regions of interest.

Clause 25: The method of Clause 23 or Clause 24, wherein identifying the sub-regions of interest comprises:
identifying the sub-regions of interest that identify a set of environmental features, the set of environmental features comprising a first environmental feature associated with a first type of environmental feature and a second environmental feature associated with a second type of environmental feature.

Clause 26: The method of any one of Clauses 21 through 25, wherein identifying the environmental feature comprises:
identifying the environmental feature that identifies at least one of a traffic signal, a traffic sign, a traffic marker, a road characteristic, a bicycle, a pedestrian, or a vehicle.

Clause 27: The method of any one of Clauses 21 through 26, wherein routing the region of interest to the image sensor comprises:
routing the region of interest to at least one of a camera, a location sensor, an accelerometer, a speed sensor, a gyroscope, a position sensor, a weather sensor, a traffic data sensor, a radar sensor, or a lidar sensor.

Clause 28: The method of Clause 27, wherein receiving the first sensor data comprises:
receiving the first sensor data from the image sensor.

Clause 29: The method of Clause 27 or Clause 28, further comprising:
transmitting a command to cause the image sensor to adjust an image sensor parameter based on the region of interest.

Clause 30: The method of Clause 29, wherein transmitting the command comprises:
transmitting the command to further cause the image sensor to adjust at least one of brightness, contrast, white balance, gain, tint, exposure, saturation, or color balance.

Clause 31: The method of Clause 29 or Clause 30, wherein transmitting the command comprises:
transmitting the command to further cause the image sensor to generate additional sensor data associated with the image sensor based on the adjusted image sensor parameter.

Clause 32: The method of Clause 31, wherein transmitting the command further comprises:
transmitting the command to further cause the image sensor to process the second sensor data to generate an image of a scene and provide the image to an autonomous vehicle system.

Clause 33: The method of any one of Clauses 21 through 32, wherein receiving the first sensor data comprises:
receiving the first sensor data that is associated with a first frame, wherein identifying the region of interest comprises:
identifying a region of interest of a second frame identified based on the first frame.

Clause 34: The method of any one of Clauses 21 through 33, further comprising:
identifying an intrinsic parameter of an image sensor,
wherein transposing the location of the environmental feature from the map based coordinate system to the image sensor based coordinate system comprises:
transposing the location of the environmental feature from the map based coordinate system to the image sensor based coordinate system based on the intrinsic parameter of the image sensor.

Clause 35: The method of any one of Clauses 21 through 34, wherein identifying the location of the environmental feature within the map based coordinate system comprises:
identifying the location of the environmental feature within a three-dimensional coordinate system,
wherein transposing the location of the environmental feature from the map based coordinate system to the image sensor based coordinate system comprises:
transposing the location of the environmental feature from the three-dimensional coordinate system to a two-dimensional coordinate system,
wherein identifying the region of interest in the image sensor based coordinate system comprises:
identifying the region of interest in the two-dimensional coordinate system.

Clause 36: The method of any one of Clauses 21 through 35, further comprising:
receiving region of interest data associated with the vehicle and indicative of a type of environmental feature, wherein the environmental feature is associated with the type of environmental feature.

Clause 37: The method of any one of Clauses 21 through 36, further comprising:
receiving updated sensor data associated with a third sensor of the vehicle;
processing the updated sensor data using the neural network;
identifying a location of a second environmental feature within the map based coordinate system based at least in part on processing the updated sensor data using the neural network;
transposing the location of the second environmental feature from the map based coordinate system to the image sensor based coordinate system; and
identifying a second region of interest in the image sensor based coordinate system based at least in part on the second environmental feature,
wherein routing the second region of interest comprises:
   routing the second region of interest based on identifying the second region of interest.

Clause 38: The method of any one of Clauses 21 through 37, wherein identifying the region of interest and identifying the second region of interest comprises:
identifying the second region of interest and the region of interest that are associated with different coordinates in the image sensor based coordinate system.

Clause 39: The method of any one of Clauses 1 through 17, wherein the image sensor adjusts an image sensor parameter based on the region of interest, wherein the image sensor parameter comprises at least one of brightness, contrast, white balance, gain, tint, exposure, saturation, or color balance.

Clause 40: The system of Clause 18 or Clause 19, wherein to receive the vehicle data execution of the instructions further causes the at least one processor to:
receive at least one of speed data associated with a speed sensor and indicative of a speed of the vehicle, acceleration data associated with an accelerometer and indicative of an acceleration of the vehicle, location data associated with a location sensor and indicative of a location of the vehicle, route data associated with a first sensor and indicative of a route of the vehicle, or mileage data associated with a second sensor and indicative of a mileage of the vehicle.

Clause 41: The system of any one of Clauses 18, 19, or 40, wherein to identify the region of interest execution of the instructions further causes the at least one processor to:
identify sub-regions of interest, wherein each of the sub-regions of interest is based on a particular environmental feature.

Clause 42: The system of Clause 41, wherein to identify the sub-regions of interest execution of the instructions further causes the at least one processor to:
identify non-contiguous regions of interest.

Clause 43: The system of Clause 41 or Clause 42, wherein to identify the sub-regions of interest execution of the instructions further causes the at least one processor to:
identify the sub-regions of interest that identify a set of environmental features, the set of environmental features comprising a first environmental feature associated with a first type of environmental feature and a second environmental feature associated with a second type of environmental feature.

Clause 44: The system of any one of Clauses 18, 19, or 40 through 43, wherein to identify the environmental feature execution of the instructions further causes the at least one processor to:
identify the environmental feature that identifies at least one of a traffic signal, a traffic marker, a road characteristic, a bicycle, a vehicle, a pedestrian, or a traffic sign.

Clause 45: The system of any one of Clauses 18, 19, or 40 through 44, wherein execution of the instructions further causes the at least one processor to:
transmit a command to cause the image sensor to adjust an image sensor parameter based on the region of interest.

Clause 46: The system of Clause 45, wherein to transmit the command execution of the instructions further causes the at least one processor to:
transmit the command to further cause the image sensor to adjust at least one of brightness, contrast, white balance, gain, tint, exposure, saturation, or color balance.

Clause 47: The system of Clause 45 or Clause 46, wherein to transmit the command execution of the instructions further causes the at least one processor to:
transmit the command to further cause the image sensor to generate the sensor data based on the adjusted image sensor parameter.

Clause 48: The method of Clause 47, wherein to transmit the command execution of the instructions further causes the at least one processor to:
transmit the command to further cause the image sensor to process the sensor data to generate an image of a scene and provide the image to an autonomous vehicle system.

Clause 49: The system of any one of Clauses 18, 19, or 40 through 48, wherein execution of the instructions further causes the at least one processor to:
identify an intrinsic parameter of the image sensor,
wherein to transpose the location of the environmental feature from the map based coordinate system to the image sensor based coordinate system execution of the instructions further causes the at least one processor to:
transpose the location of the environmental feature from the map based coordinate system to the image sensor based coordinate system based on the intrinsic parameter of the image sensor.

Clause 50: The system of any one of Clauses 18, 19, or 40 through 49, wherein to identify the environmental feature in the map based coordinate system execution of the instructions further causes the at least one processor to:
identify the environmental feature in a three-dimensional coordinate system,
wherein to transpose the location of the environmental feature from the map based coordinate system to the image sensor based coordinate system execution of the instructions further causes the at least one processor to:
transpose the location of the environmental feature from the three-dimensional coordinate system to a two-dimensional coordinate system,
wherein to identify the region of interest in the image sensor based coordinate system execution of the instructions further causes the at least one processor to:
identify the region of interest in the two-dimensional coordinate system.

Clause 51: The system of any one of Clauses 18, 19, or 40 through 50, wherein to identify the environmental feature execution of the instructions further causes the at least one processor to:
identify the location of the environmental feature relative to the location of the vehicle,
wherein to identify the region of interest in the image sensor based coordinate system execution of the instructions further causes the at least one processor to:
identify the region of interest further based at least in part on the location of the environmental feature relative to the location of the vehicle.

Clause 52: The system of any one of Clauses 18, 19, or 40 through 51, wherein execution of the instructions further causes the at least one processor to:
receive region of interest data associated with the vehicle and indicative of a type of environmental feature, wherein the environmental feature is associated with the type of environmental feature.

Clause 53: The system of any one of Clauses 18, 19, or 40 through 52, wherein execution of the instructions further causes the at least one processor to:
receive updated vehicle data associated with the vehicle and indicative of at least an updated location of the vehicle within the environment;
identify the updated location of the vehicle based at least in part on the updated vehicle data;
identify a second environmental feature, in the map based coordinate system, associated with the updated location of the vehicle;
transpose a location of the second environmental feature from the map based coordinate system to the image sensor based coordinate system; and
identify a second region of interest in the image sensor based coordinate system based at least in part on the second environmental feature;
wherein to route the second region of interest execution of the instructions further causes the at least one processor to:
   route the second region of interest based on identifying the second region of interest.

Clause 54: The method of Clause 53, wherein to identify the region of interest and identify the second region of interest execution of the instructions further causes the at least one processor to:
identify the second region of interest and the region of interest that are associated with different coordinates in the image sensor based coordinate system.

Clause 55: The system of any one of Clauses 18, 19, or 40 through 54, wherein execution of the instructions further causes the at least one processor to:
identify at least one annotation associated with the location of the vehicle, wherein the at least one annotation identifies the environmental feature.

Clause 56: The at least one non-transitory storage media of Clause 20, wherein the image sensor adjusts an image sensor parameter based on the region of interest, wherein the image sensor parameter comprises at least one of brightness, contrast, white balance, gain, tint, exposure, saturation, or color balance.

Clause 57: The at least one non-transitory storage media of Clause 20 or 56, wherein to receive the vehicle data execution of the instructions further causes the computing system to:
receive at least one of speed data associated with a speed sensor and indicative of a speed of the vehicle, acceleration data associated with an accelerometer and indicative of an acceleration of the vehicle, location data associated with a location sensor and indicative of a location of the vehicle, route data associated with a first sensor and indicative of a route of the vehicle, or mileage data associated with a second sensor and indicative of a mileage of the vehicle.

Clause 58: The at least one non-transitory storage media of any one of Clauses 20, 56, or 57, wherein to identify the region of interest execution of the instructions further causes the computing system to:
identify sub-regions of interest, wherein each of the sub-regions of interest is based on a particular environmental feature.

Clause 59: The at least one non-transitory storage media of Clause 58, wherein to identify the sub-regions of interest execution of the instructions further causes the computing system to:
identify non-contiguous regions of interest.

Clause 60: The at least one non-transitory storage media of Clause 58 or Clause 59, wherein to identify the sub-regions of interest execution of the instructions further causes the computing system to:
identify the sub-regions of interest that identify a set of environmental features, the set of environmental features comprising a first environmental feature associated with a first type of environmental feature and a second environmental feature associated with a second type of environmental feature.

Clause 61: The at least one non-transitory storage media of any one of Clauses 20 or 56 through 60, wherein to identify the environmental feature execution of the instructions further causes the computing system to:
identify the environmental feature that identifies at least one of a traffic signal, a traffic marker, a road characteristic, a bicycle, a vehicle, a pedestrian, or a traffic sign.

Clause 62: The at least one non-transitory storage media of any one of Clauses 20 or 56 through 61, wherein execution of the instructions further causes the computing system to:
transmit a command to cause the image sensor to adjust an image sensor parameter based on the region of interest.

Clause 63: The at least one non-transitory storage media of Clause 62, wherein to transmit the command execution of the instructions further causes the computing system to:
transmit the command to further cause the image sensor to adjust at least one of brightness, contrast, white balance, gain, tint, exposure, saturation, or color balance.

Clause 64: The at least one non-transitory storage media of Clause 62 or Clause 63, wherein to transmit the command execution of the instructions further causes the computing system to:
transmit the command to further cause the image sensor to generate the sensor data based on the adjusted image sensor parameter.

Clause 65: The at least one non-transitory storage media of Clause 64, wherein to transmit the command execution of the instructions further causes the computing system to:
transmit the command to further cause the image sensor to process the sensor data to generate an image of a scene and provide the image to an autonomous vehicle system.

Clause 66: The at least one non-transitory storage media of any one of Clauses 20 or 56 through 65, wherein execution of the instructions further causes the computing system to:
identify an intrinsic parameter of the image sensor,
wherein to transpose the location of the environmental feature from the map based coordinate system to the image sensor based coordinate system execution of the instructions further causes the computing system to:
transpose the location of the environmental feature from the map based coordinate system to the image sensor based coordinate system based on the intrinsic parameter of the image sensor.

Clause 67: The at least one non-transitory storage media of any one of Clauses 20 or 56 through 66, wherein to identify the environmental feature in the map based coordinate system execution of the instructions further causes the computing system to:
identify the environmental feature in a three-dimensional coordinate system,
wherein to transpose the location of the environmental feature from the map based coordinate system to the image sensor based coordinate system execution of the instructions further causes the computing system to:
transpose the location of the environmental feature from the three-dimensional coordinate system to a two-dimensional coordinate system,
wherein to identify the region of interest in the image sensor based coordinate system execution of the instructions further causes the computing system to:
identify the region of interest in the two-dimensional coordinate system.

Clause 68: The at least one non-transitory storage media of any one of Clauses 20 or 56 through 67, wherein to identify the environmental feature execution of the instructions further causes the computing system to:
identify the location of the environmental feature relative to the location of the vehicle,
wherein to identify the region of interest in the image sensor based coordinate system execution of the instructions further causes the computing system to:
identify the region of interest further based at least in part on the location of the environmental feature relative to the location of the vehicle.

Clause 69: The at least one non-transitory storage media of any one of Clauses 20 or 56 through 68, wherein execution of the instructions further causes the computing system to:
receive region of interest data associated with the vehicle and indicative of a type of environmental feature, wherein the environmental feature is associated with the type of environmental feature.

Clause 70: The at least one non-transitory storage media of any one of Clauses 20 or 56 through 69, wherein execution of the instructions further causes the computing system to:
receive updated vehicle data associated with the vehicle and indicative of at least an updated location of the vehicle within the environment;
identify the updated location of the vehicle based at least in part on the updated vehicle data;
identify a second environmental feature, in the map based coordinate system, associated with the updated location of the vehicle;
transpose a location of the second environmental feature from the map based coordinate system to the image sensor based coordinate system; and
identify a second region of interest in the image sensor based coordinate system based at least in part on the second environmental feature;
wherein to route the second region of interest execution of the instructions further causes the computing system to:
   route the second region of interest based on identifying the second region of interest.

Clause 71: The at least one non-transitory storage media of Clause 70, wherein to identify the region of interest and identify the second region of interest execution of the instructions further causes the computing system to:
identify the second region of interest and the region of interest that are associated with different coordinates in the image sensor based coordinate system.

Clause 72: The at least one non-transitory storage media of any one of Clauses 20 or 56 through 71, wherein execution of the instructions further causes the computing system to:
identify at least one annotation associated with the location of the vehicle, wherein the at least one annotation identifies the environmental feature.

Clause 73: A system, comprising:
at least one processor, and
at least one non-transitory storage media storing instructions that, when executed by the at least one processor, cause the at least one processor to:
   receive first sensor data associated with a first sensor of a vehicle;
   process the first sensor data using a neural network;
   identify a location of an environmental feature within a map based coordinate system based at least in part on processing the first sensor data using the neural network;
   transpose the location of the environmental feature from the map based coordinate system to an image sensor based coordinate system;
   identify a region of interest in the image sensor based coordinate system based at least in part on the environmental feature; and
   route the region of interest to an image sensor for image signal processing of second sensor data associated with a second sensor based on the region of interest.

Clause 74: The system of Clause 73, wherein to receive the first sensor data execution of the instructions further causes the at least one processor to:
receive at least one of camera data associated with a first image sensor and indicative of a camera image, location data associated with a location sensor and indicative of a location of the vehicle, acceleration data associated with an accelerometer and indicative of an acceleration of the vehicle, speed data associated with a speed sensor and indicative of a speed of the vehicle, rotation data associated with a gyroscope and indicative of a rotation of the vehicle, a position data associated with a position sensor and indicative of a position of the vehicle, weather data associated with a weather sensor and indicative of weather, traffic data associated with a traffic sensor and indicative of traffic, lidar data associated with a second image sensor and indicative of a lidar image, or radar data associated with a third image sensor and indicative of a radar image.

Clause 75: The system of Clause 73 or Clause 74, wherein to identify the region of interest execution of the instructions further causes the at least one processor to:
identify sub-regions of interest, wherein each of the sub-regions of interest is based on a particular environmental feature.

Clause 76: The system of Clause 75, wherein to identify the sub-regions of interest execution of the instructions further causes the at least one processor to:
identify non-contiguous regions of interest.

Clause 77: The system of Clause 75 or Clause 76, wherein to identify the sub-regions of interest execution of the instructions further causes the at least one processor to:
identify the sub-regions of interest that identify a set of environmental features, the set of environmental features comprising a first environmental feature associated with a first type of environmental feature and a second environmental feature associated with a second type of environmental feature.

Clause 78: The system of any one of Clauses 73 through 77, wherein to identify the environmental feature execution of the instructions further causes the at least one processor to:
identify the environmental feature that identifies at least one of a traffic signal, a traffic sign, a traffic marker, a road characteristic, a bicycle, a pedestrian, or a vehicle.

Clause 79: The system of any one of Clauses 73 through 78, wherein to route the region of interest to the image sensor execution of the instructions further causes the at least one processor to:
route the region of interest to at least one of a camera, a location sensor, an accelerometer, a speed sensor, a gyroscope, a position sensor, a weather sensor, a traffic data sensor, a radar sensor, or a lidar sensor.

Clause 80: The system of Clause 79, wherein to receive the first sensor data execution of the instructions further causes the at least one processor to:
receive the first sensor data from the image sensor.

Clause 81: The system of Clause 79 or Clause 80, wherein execution of the instructions further causes the at least one processor to:
transmit a command to cause the image sensor to adjust an image sensor parameter based on the region of interest.

Clause 82: The system of Clause 81, wherein to transmit the command execution of the instructions further causes the at least one processor to:
transmit the command to further cause the image sensor to adjust at least one of brightness, contrast, white balance, gain, tint, exposure, saturation, or color balance.

Clause 83: The system of Clause 81 or Clause 82, wherein to transmit the command execution of the instructions further causes the at least one processor to:
transmit the command to further cause the image sensor to generate additional sensor data associated with the image sensor based on the adjusted image sensor parameter.

Clause 84: The system of Clause 83, wherein to transmit the command execution of the instructions further causes the at least one processor to:
transmit the command to further cause the image sensor to process the second sensor data to generate an image of a scene and provide the image to an autonomous vehicle system.

Clause 85: The system of any one of Clauses 73 through 84, wherein to receive the first sensor data execution of the instructions further causes the at least one processor to:
receive the first sensor data that is associated with a first frame,
wherein to identify the region of interest execution of the instructions further causes the at least one processor to:
identify a region of interest of a second frame identified based on the first frame.

Clause 86: The system of any one of Clauses 73 through 85, wherein execution of the instructions further causes the at least one processor to:
identify an intrinsic parameter of an image sensor,
wherein to transpose the location of the environmental feature from the map based coordinate system to the image sensor based coordinate system execution of the instructions further causes the at least one processor to:
transpose the location of the environmental feature from the map based coordinate system to the image sensor based coordinate system based on the intrinsic parameter of the image sensor.

Clause 87: The system of any one of Clauses 73 through 86, wherein to identify the location of the environmental feature within the map based coordinate system execution of the instructions further causes the at least one processor to:
identify the location of the environmental feature within a three-dimensional coordinate system,
wherein to transpose the location of the environmental feature from the map based coordinate system to the image sensor based coordinate system execution of the instructions further causes the at least one processor to:
transpose the location of the environmental feature from the three-dimensional coordinate system to a two-dimensional coordinate system,
wherein to identify the region of interest in the image sensor based coordinate system execution of the instructions further causes the at least one processor to:
identify the region of interest in the two-dimensional coordinate system.

Clause 88: The system of any one of Clauses 73 through 87, wherein execution of the instructions further causes the at least one processor to:
receive region of interest data associated with the vehicle and indicative of a type of environmental feature, wherein the environmental feature is associated with the type of environmental feature.

Clause 89: The system of any one of Clauses 73 through 88, wherein execution of the instructions further causes the at least one processor to:
receive updated sensor data associated with a third sensor of the vehicle;
process the updated sensor data using the neural network;
identify a location of a second environmental feature within the map based coordinate system based at least in part on processing the updated sensor data using the neural network;
transpose the location of the second environmental feature from the map based coordinate system to the image sensor based coordinate system; and
identify a second region of interest in the image sensor based coordinate system based at least in part on the second environmental feature,
wherein to route the second region of interest execution of the instructions further causes the at least one processor to:
   route the second region of interest based on identifying the second region of interest.

Clause 90: The system of any one of Clauses 73 through 89, wherein to identify the region of interest and identify the second region of interest execution of the instructions further causes the at least one processor to:
identify the second region of interest and the region of interest that are associated with different coordinates in the image sensor based coordinate system.

Clause 91: At least one non-transitory storage media storing instructions that, when executed by a computing system comprising a processor, cause the computing system to: receive first sensor data associated with a first sensor of a vehicle;
process the first sensor data using a neural network;
identify a location of an environmental feature within a map based coordinate system based at least in part on processing the first sensor data using the neural network;
transpose the location of the environmental feature from the map based coordinate system to an image sensor based coordinate system;
identify a region of interest in the image sensor based coordinate system based at least in part on the environmental feature; and
route the region of interest to an image sensor for image signal processing of second sensor data associated with a second sensor based on the region of interest.

Clause 92: The at least one non-transitory storage media of Clause 91, wherein to receive the first sensor data execution of the instructions further causes the computing system to:
receive at least one of camera data associated with a first image sensor and indicative of a camera image, location data associated with a location sensor and indicative of a location of the vehicle, acceleration data associated with an accelerometer and indicative of an acceleration of the vehicle, speed data associated with a speed sensor and indicative of a speed of the vehicle, rotation data associated with a gyroscope and indicative of a rotation of the vehicle, a position data associated with a position sensor and indicative of a position of the vehicle, weather data associated with a weather sensor and indicative of weather, traffic data associated with a traffic sensor and indicative of traffic, lidar data associated with a second image sensor and indicative of a lidar image, or radar data associated with a third image sensor and indicative of a radar image.

Clause 93: The at least one non-transitory storage media of Clause 91 or Clause 92, wherein to identify the region of interest execution of the instructions further causes the computing system to:
identify sub-regions of interest, wherein each of the sub-regions of interest is based on a particular environmental feature.

Clause 94: The at least one non-transitory storage media of Clause 93, wherein to identify the sub-regions of interest execution of the instructions further causes the computing system to:
identify non-contiguous regions of interest.

Clause 95: The at least one non-transitory storage media of Clause 93 or Clause 94, wherein to identify the sub-regions of interest execution of the instructions further causes the computing system to:
identify the sub-regions of interest that identify a set of environmental features, the set of environmental features comprising a first environmental feature associated with a first type of environmental feature and a second environmental feature associated with a second type of environmental feature.

Clause 96: The at least one non-transitory storage media of any one of Clauses 91 through 95, wherein to identify the environmental feature execution of the instructions further causes the computing system to:
identify the environmental feature that identifies at least one of a traffic signal, a traffic sign, a traffic marker, a road characteristic, a bicycle, a pedestrian, or a vehicle.

Clause 97: The at least one non-transitory storage media of any one of Clauses 91 through 96, wherein to route the region of interest to the image sensor execution of the instructions further causes the computing system to:
route the region of interest to at least one of a camera, a location sensor, an accelerometer, a speed sensor, a gyroscope, a position sensor, a weather sensor, a traffic data sensor, a radar sensor, or a lidar sensor.

Clause 98: The at least one non-transitory storage media of Clause 97, wherein to receive the first sensor data execution of the instructions further causes the computing system to: receive the first sensor data from the image sensor.

Clause 99: The at least one non-transitory storage media of Clause 97 or Clause 98, wherein execution of the instructions further causes the computing system to:
transmit a command to cause the image sensor to adjust an image sensor parameter based on the region of interest.

Clause 100: The at least one non-transitory storage media of Clause 99, wherein to transmit the command execution of the instructions further causes the computing system to:
transmit the command to further cause the image sensor to adjust at least one of brightness, contrast, white balance, gain, tint, exposure, saturation, or color balance.

Clause 101: The at least one non-transitory storage media of Clause 99 or Clause 100, wherein to transmit the command execution of the instructions further causes the computing system to:
transmit the command to further cause the image sensor to generate additional sensor data associated with the image sensor based on the adjusted image sensor parameter.

Clause 102: The at least one non-transitory storage media of Clause 101, wherein to transmit the command execution of the instructions further causes the computing system to:
transmit the command to further cause the image sensor to process the second sensor data to generate an image of a scene and provide the image to an autonomous vehicle system.

Clause 103: The at least one non-transitory storage media of any one of Clauses 91 through 102, wherein to receive the first sensor data execution of the instructions further causes the computing system to:
receive the first sensor data that is associated with a first frame,
wherein to identify the region of interest execution of the instructions further causes the computing system to:
identify a region of interest of a second frame identified based on the first frame.

Clause 104: The at least one non-transitory storage media of any one of Clauses 91 through 103, wherein execution of the instructions further causes the computing system to:
identify an intrinsic parameter of an image sensor,
wherein to transpose the location of the environmental feature from the map based coordinate system to the image sensor based coordinate system execution of the instructions further causes the computing system to:
transpose the location of the environmental feature from the map based coordinate system to the image sensor based coordinate system based on the intrinsic parameter of the image sensor.

Clause 105: The at least one non-transitory storage media of any one of Clauses 91 through 104, wherein to identify the location of the environmental feature within the map based coordinate system execution of the instructions further causes the computing system to:
identify the location of the environmental feature within a three-dimensional coordinate system,
wherein to transpose the location of the environmental feature from the map based coordinate system to the image sensor based coordinate system execution of the instructions further causes the computing system to:
transpose the location of the environmental feature from the three-dimensional coordinate system to a two-dimensional coordinate system,
wherein to identify the region of interest in the image sensor based coordinate system execution of the instructions further causes the computing system to:
identify the region of interest in the two-dimensional coordinate system.

Clause 106: The at least one non-transitory storage media of any one of Clauses 91 through 105, wherein execution of the instructions further causes the computing system to:
receive region of interest data associated with the vehicle and indicative of a type of environmental feature, wherein the environmental feature is associated with the type of environmental feature.

Clause 107: The at least one non-transitory storage media of any one of Clauses 91 through 106, wherein execution of the instructions further causes the computing system to:
receive updated sensor data associated with a third sensor of the vehicle;
process the updated sensor data using the neural network;
identify a location of a second environmental feature within the map based coordinate system based at least in part on processing the updated sensor data using the neural network;
transpose the location of the second environmental feature from the map based coordinate system to the image sensor based coordinate system; and
identify a second region of interest in the image sensor based coordinate system based at least in part on the second environmental feature,
wherein to route the second region of interest execution of the instructions further causes the computing system to:
   route the second region of interest based on identifying the second region of interest.

Clause 108: The at least one non-transitory storage media of any one of Clauses 91 through 107, wherein to identify the region of interest and identify the second region of interest execution of the instructions further causes the computing system to:
identify the second region of interest and the region of interest that are associated with different coordinates in the image sensor based coordinate system.

What is claimed is:

1. A method, comprising:
receiving, using at least one processor, vehicle data associated with a representation of a vehicle and indicative of at least a location of the vehicle within an environment;
identifying, using the at least one processor, the location of the vehicle based at least in part on the vehicle data;
identifying, using the at least one processor, an environmental feature in a map based coordinate system, wherein the environmental feature is associated with the location of the vehicle;
transposing, using the at least one processor, a location of the environmental feature from the map based coordinate system to an image sensor based coordinate system;
identifying, using the at least one processor, a region of interest in the image sensor based coordinate system based at least in part on the environmental feature; and
routing, using the at least one processor, the region of interest to an image sensor for image signal processing of sensor data associated with a sensor based on the region of interest.

2. The method of claim 1, wherein receiving the vehicle data comprises:
receiving at least one of speed data associated with a speed sensor and indicative of a speed of the vehicle, acceleration data associated with an accelerometer and indicative of an acceleration of the vehicle, location data associated with a location sensor and indicative of a location of the vehicle, route data associated with a first sensor and indicative of a route of the vehicle, or mileage data associated with a second sensor and indicative of a mileage of the vehicle.

3. The method of claim 1, wherein identifying the region of interest comprises:
identifying sub-regions of interest, wherein each of the sub-regions of interest is based on a particular environmental feature.

4. The method of claim 3, wherein identifying the sub-regions of interest comprises:
identifying non-contiguous regions of interest.

5. The method of claim 3, wherein identifying the sub-regions of interest comprises:
identifying the sub-regions of interest that identify a set of environmental features, the set of environmental features comprising a first environmental feature associated with a first type of environmental feature and a second environmental feature associated with a second type of environmental feature.

6. The method of claim 1, wherein identifying the environmental feature comprises:
identifying the environmental feature that identifies at least one of a traffic signal, a traffic marker, a road characteristic, a bicycle, a vehicle, a pedestrian, or a traffic sign.

7. The method of claim 1, further comprising:
transmitting a command to cause the image sensor to adjust an image sensor parameter based on the region of interest.

8. The method of claim 7, wherein transmitting the command comprises:
transmitting the command to further cause the image sensor to adjust at least one of brightness, contrast, white balance, gain, tint, exposure, saturation, or color balance.

9. The method of claim 7, wherein transmitting the command comprises:
transmitting the command to further cause the image sensor to generate the sensor data based on the adjusted image sensor parameter.

10. The method of claim 9, wherein transmitting the command further comprises:
transmitting the command to further cause the image sensor to process the sensor data to generate an image of a scene and provide the image to an autonomous vehicle system.

11. The method of claim 1, further comprising:
identifying an intrinsic parameter of the image sensor,
wherein transposing the location of the environmental feature from the map based coordinate system to the image sensor based coordinate system comprises:
transposing the location of the environmental feature from the map based coordinate system to the image sensor based coordinate system based on the intrinsic parameter of the image sensor.

12. The method of claim 1, wherein identifying the environmental feature in the map based coordinate system comprises:
identifying the environmental feature in a three-dimensional coordinate system, and
wherein transposing the location of the environmental feature from the map based coordinate system to the image sensor based coordinate system comprises:
transposing the location of the environmental feature from the three-dimensional coordinate system to a two-dimensional coordinate system,
wherein identifying the region of interest in the image sensor based coordinate system comprises:
identifying the region of interest in the two-dimensional coordinate system.

13. The method of claim 1, wherein identifying the environmental feature comprises:
identifying the location of the environmental feature relative to the location of the vehicle,
wherein identifying the region of interest in the image sensor based coordinate system comprises:
identifying the region of interest further based at least in part on the location of the environmental feature relative to the location of the vehicle.

14. The method of claim 1, further comprising:
receiving region of interest data associated with the vehicle and indicative of a type of environmental feature, wherein the environmental feature is associated with the type of environmental feature.

15. The method of claim 1, further comprising:
receiving updated vehicle data associated with the vehicle and indicative of at least an updated location of the vehicle within the environment;
identifying the updated location of the vehicle based at least in part on the updated vehicle data;
identifying a second environmental feature, in the map based coordinate system, associated with the updated location of the vehicle;
transposing a location of the second environmental feature from the map based coordinate system to the image sensor based coordinate system; and
identifying a second region of interest in the image sensor based coordinate system based at least in part on the second environmental feature;
wherein routing the second region of interest comprises:
routing the second region of interest based on identifying the second region of interest.

16. The method of claim 15, wherein identifying the region of interest and identifying the second region of interest comprises:
identifying the second region of interest and the region of interest that are associated with different coordinates in the image sensor based coordinate system.

17. The method of claim 1, further comprising:
identifying at least one annotation associated with the location of the vehicle, wherein the at least one annotation identifies the environmental feature.

18. A system, comprising:
at least one processor, and
at least one non-transitory storage media storing instructions that, when executed by the at least one processor, cause the at least one processor to:
receive vehicle data associated with a representation of a vehicle and indicative of at least a location of the vehicle within an environment;
identify the location of the vehicle based at least in part on the vehicle data;
identify an environmental feature in a map based coordinate system,
wherein the environmental feature is associated with the location of the vehicle;
transpose a location of the environmental feature from the map based coordinate system to an image sensor based coordinate system;
identify a region of interest in the image sensor based coordinate system based at least in part on the environmental feature; and
route the region of interest to an image sensor for image signal processing of sensor data associated with a sensor based on the region of interest.

19. The system of claim 18, wherein the image sensor adjusts an image sensor parameter based on the region of interest, wherein the image sensor parameter comprises at least one of brightness, contrast, white balance, gain, tint, exposure, saturation, or color balance.

20. At least one non-transitory storage media storing instructions that, when executed by a computing system comprising a processor, cause the computing system to:
receive vehicle data associated with a representation of a vehicle and indicative of at least a location of the vehicle within an environment;
identify the location of the vehicle based at least in part on the vehicle data;
identify an environmental feature in a map based coordinate system, wherein the environmental feature is associated with the location of the vehicle;
transpose a location of the environmental feature from the map based coordinate system to an image sensor based coordinate system;
identify a region of interest in the image sensor based coordinate system based at least in part on the environmental feature; and
route the region of interest to an image sensor for image signal processing of sensor data associated with a sensor based on the region of interest.
